(19) United States
(12) Patent Application Publication
(10) Pub. No.: US 2024/0421649 A1
(43) Pub. Date: Dec. 19, 2024

(54) WINDING STATOR WITH BAR CONDUCTORS FOR AN ELECTRIC MACHINE

(71) Applicant: ELDOR CORPORATION S.P.A., ORSENIGO (COMO) (IT)

(72) Inventors: Pasquale FORTE, ORSENIGO (IT); Luca ZAI, ORSENIGO (IT); Davide ROSSI, ORSENIGO (IT)

(21) Appl. No.: 18/833,253

(22) PCT Filed: Jan. 26, 2023
(86) PCT No.: PCT/IB2023/050672

§ 371 Date: Jul. 25, 2024

(30) Foreign Application Priority Data
Jan. 28, 2022 (IT) 102022000001445

(51) Int. Cl. H02K 3/28

(52) U.S. Cl. CPC H02K 3/28

(57) ABSTRACT

It is disclosed a winding stator with bar conductors for an electric machine. The stator comprises a stator core and a stator winding. The stator core comprises a plurality of slots extending along the axial direction of the stator core. The stator winding comprises a plurality of bar conductors connected together in series to form the stator winding. Each slot comprises a plurality of first and/or second legs of different bar conductors arranged side-by-side along a radial direction of the stator core defined by the secondary extension of the stator core. The plurality of bar conductors is arranged at the insertion side in groups comprising at least two bar conductors having the respective first legs arranged side-by-side along the radial direction of a slot and having the respective second legs arranged side-by-side along the radial direction of another slot.

### BACKGROUND

### Technical Field

The present disclosure generally relates to the field of electric machines.

More particularly, the present disclosure concerns a winding stator with bar conductors.

### Description of the Related Art

It is known to make stators for electric machines for use in electric or hybrid vehicles, in which the stator winding is formed by a plurality of bent electric bar conductors (“hairpins”) connected appropriately to each other in order to realize the stator winding.

The bar conductors typically have a rectangular or square cross-section and are preformed into a “U” shape starting from rectilinear bar conductors, thus obtaining shaped bar conductors in which each of them comprises two parallel rectilinear arms (also called legs) connected on one side by means of a connecting portion (also called “chignon”), while on the other side the two arms have a respective free end.

The stator winding is formed by inserting the preformed bar conductors into the slots of a stator core on a first side thereof indicated with “insertion side”, while the free ends project with respect to a second side of the stator core opposite to the first one indicated with “twisting side”.

The free ends of the twisting side are then suitably bent (i.e. twisted) in a circumferential direction so that the bent free ends of two different conductors face each other and can be welded together, thus electrically connecting the two bar conductors considered and thus realizing the stator winding, wherein each phase can be composed of a single winding path or of two or more winding paths connected in parallel or series and electrically balanced.

In order to obtain the desired number of design turns, jumpers (e.g. at the twisting side) are used to make suitable electrical connections between the projecting free ends of different non-contiguous bar conductors, wherein the two projecting ends are circumferentially spaced apart by a certain quantity measured in slot pitches, such as for example 3, 4 or more slot pitches.

The use of the jumpers allows to increase the flexibility of the electrical diagrams realizable in terms of number of turns in series per phase and number of parallel paths per phase and allows to obtain the balance of each phase of the winding of the electric machine, but has the following disadvantages:
it increases the complexity of realization of the stator, as it complicates the process of welding and resinizing the head of the stator at the twisting side;
it increases the space occupied by the head of the stator from the side on which it is positioned, for example at the twisting side;
it increases the material used to realize the stator and thus increases the weight of the stator.

U.S. Pat. No. 8,552,611 discloses the use of groups of five radially side-by-side “S”-shaped bar conductors (see FIGS. 2 and 5a-5c), wherein the two legs of each conductor of the group are inserted into the slots of the stator core so as to be spaced circumferentially by a certain quantity measured in slot pitches: this allows to reduce the space occupied by the head of the stator at the insertion side.

U.S. Pat. No. 9,899,888 also discloses the use of groups of four radially side-by-side bar conductors (see FIGS. 9A-9B), wherein the two legs of each conductor of the group are spaced five slot pitches apart in circumferential direction and are spaced four layers apart in radial direction.

The stators described in U.S. Pat. Nos. 8,552,611 and 9,899,888 allow to reduce the space occupied by the head of the stator at the insertion side, but do not allow to minimize the number of jumpers used.

### BRIEF SUMMARY

The present disclosure concerns a winding stator with bar conductors as defined in the appended claims 1 and 8 and their embodiments described in the dependent claims 2-7, 9-12 and 14-18.

The Applicant has perceived that the winding stator with bar conductors according to the present disclosure can minimize (or even eliminate) the number of jumpers used to obtain a certain electrical configuration (for example, a certain number of paths in parallel), while maintaining at the same time the flexibility of the electrical diagrams realizable for the electric machine and maintaining (or even increasing) the balance of each phase of the electric machine: in this way the realization of the stator is easier, the space occupied by the head of the stator at the twisting side is reduced, the material used is less and therefore the weight of the stator is lower.

In particular, it is possible to connect in series a greater number of bar conductors within each path in parallel, thus reducing the number of jumpers used to connect the different paths in parallel to a minimum.

In some cases it is possible to obtain a winding with several paths in parallel and electrically balanced, eliminating the use of jumpers.

The basic idea is to use at the insertion side groups of bar conductors having a circumferential distance defined between the slots in which the two legs of each conductor of the insertion side are inserted, then at the twisting side electrically connect the bent projecting end of a first leg of a conductor with the bent projecting end of a first leg of another conductor that is radially adjacent at the twisting side, and similarly electrically connect the bent projecting end of a second leg of a conductor with the bent projecting end of a second leg of another conductor that is radially adjacent at the twisting side, wherein, alternatively, at least one between a first circumferential angular distance between the slots in which the first legs of the bent projecting ends at the twisting side are inserted and a second circumferential angular distance between the slots in which the corresponding second legs of the bent projecting ends at the twisting side are inserted is equal to the circumferential angular distance at the insertion side between the slots in which the first and second legs of each conductor of the groups of conductors are inserted, or wherein the first and second circumferential angular distances at the twisting side are equal to each other and different from the circumferential angular distance at the insertion side and furthermore a further first distance is different from the first distance and/or a further second distance is different from the second distance.

One embodiment of the present disclosure is an electric or hybrid vehicle as defined in the appended claims 13 and 19.

### BRIEF DESCRIPTION OF THE SEVERAL VIEWS OF THE DRAWINGS

Additional features and advantages of the disclosure will become more apparent from the description which follows of an embodiment and the variants thereof, provided by way of example with reference to the appended drawings, in which:

FIG. 1 shows a perspective view of a winding stator with groups of two bar conductors arranged in a crown according to a first embodiment of the disclosure;

FIGS. 2A and 2B show two perspective views of a stator core according to the disclosure;

FIG. 3A shows in more detail a perspective view of the insertion side of the stator of the first embodiment;

FIG. 3B shows in more detail a perspective view of the twisting side of the stator of the first embodiment;

FIG. 4A shows a top view of the insertion side of the stator of the first embodiment;

FIG. 4B shows a top view of the twisting side of the stator of the first embodiment;

FIG. 5 shows a side view of the winding stator with bar conductors of the first embodiment;

FIGS. 6A-6B show in more detail a perspective view of a group composed of two bar conductors of the stator of the first embodiment;

FIG. 7 shows a perspective view of a plurality of groups composed of two bar conductors at the insertion side of the stator of the first embodiment;

FIG. 8 shows a top view of the plurality of groups composed of two bar conductors of FIG. 7 at the insertion side;

FIG. 9 shows a perspective view of the plurality of groups composed of two bar conductors of FIG. 8 at the twisting side;

FIG. 10 shows a top view of the plurality of groups composed of two bar conductors of FIG. 8 at the twisting side;

FIGS. 11A-11B show in more detail a perspective view of the projecting portion of two bar conductors at the twisting side of the first embodiment;

FIG. 11C shows a top view at the twisting side of the projecting portion of the two bar conductors of FIGS. 11A-11B;

FIGS. 11D-11E show in more detail a perspective view of the projecting portion of further two bar conductors at the twisting side of the first embodiment;

FIG. 11F shows a top view at the twisting side of the projecting portion of the two bar conductors of FIGS. 11D-11E;

FIG. 12 shows a perspective view of a winding stator with groups of three bar conductors according to a second embodiment of the disclosure;

FIG. 13A shows in more detail a perspective view of the insertion side of the stator of the second embodiment;

FIG. 13B shows in more detail a perspective view of the twisting side of the stator of the second embodiment;

FIG. 14A shows a top view of the insertion side of the stator of the second embodiment;

FIG. 14B shows a top view of the twisting side of the stator of the second embodiment;

FIG. 15 shows in more detail a perspective view of a group composed of three bar conductors of the insertion side of the stator of the second embodiment;

FIG. 16 shows a perspective view of a plurality of groups composed of three bar conductors of the insertion side of the stator of the second embodiment;

FIG. 17 shows a top view of the plurality of groups composed of three bar conductors of FIG. 16 at the insertion side;

FIG. 18 shows in more detail a perspective view of the projecting portion of some bar conductors at the twisting side of the second embodiment;

FIG. 19 shows a top view of the plurality of groups composed of three bar conductors of FIG. 17 at the twisting side;

FIGS. 20A-20B show two perspective views of a winding stator with two winding portions and groups of two bar conductors according to a third embodiment of the disclosure;

FIG. 21 shows in more detail a perspective view of the insertion side of the stator of the third embodiment;

FIG. 22 shows in more detail a perspective view of the twisting side of the stator of the third embodiment;

FIG. 23A shows a top view of the insertion side of the stator of the third embodiment;

FIG. 23B shows a top view of the twisting side of the stator of the third embodiment;

FIG. 24 shows in more detail a perspective view of two groups each composed of two bar conductors at the insertion side of the stator of the third embodiment;

FIG. 25 shows a top view of the two groups of conductors of FIG. 24;

FIG. 26 shows a perspective view of a plurality of groups composed of two bar conductors of the insertion side of the stator of the third embodiment;

FIG. 27 shows a perspective view of a plurality of groups composed of two bar conductors of the twisting side of the stator of the third embodiment;

FIG. 28 shows a top view of the plurality of groups of two bar conductors of FIG. 26 at the insertion side;

FIG. 29 shows a top view of the plurality of groups of two bar conductors of FIG. 26 at the twisting side;

FIG. 30 shows in more detail a perspective view of the projecting portion of four bar conductors at the twisting side of the third embodiment;

FIG. 31 shows in detail a top view of a group composed of four bar conductors at the insertion side of the stator according to a fourth embodiment of the disclosure.

### DETAILED DESCRIPTION

It should be observed that, in the following description, identical or analogous blocks, components or modules are indicated in the figures with the same numerical references, even if they are shown in different embodiments of the disclosure.

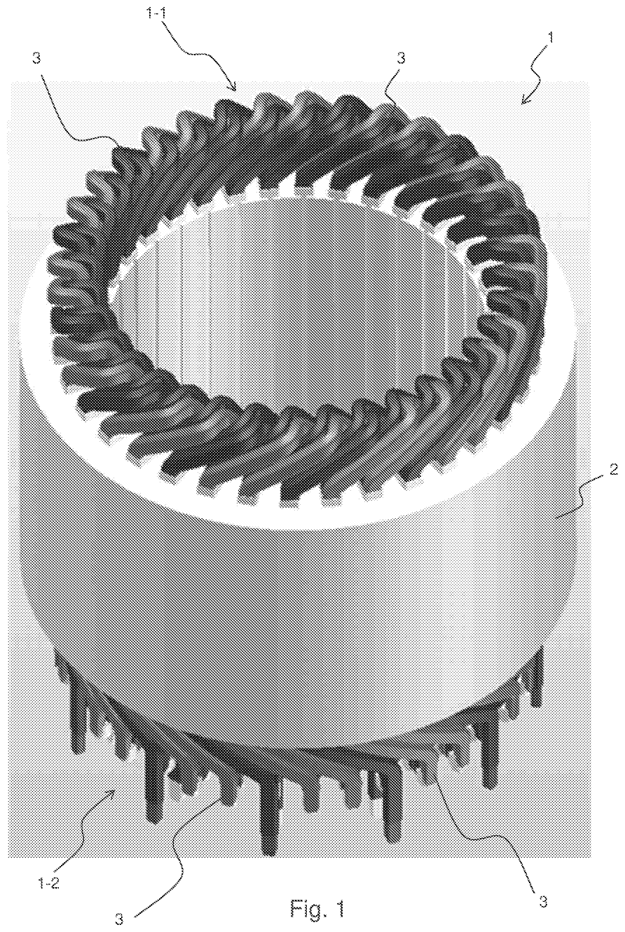

With reference to FIGS. 1, 3A, 3B, 4A, 4B, 5, 6, 7, 8, 9, 10, 11A, 11B, there is shown a first embodiment of the disclosure in which a winding stator 1 with bar conductors with one crown is realized using a plurality of groups each formed by two side-by-side bar conductors, wherein the distance in the angular direction between the slots in which the two legs of each bar conductor at the insertion side is equal to four slots are inserted.

The bar conductors (commonly referred to as “hairpins”) are typically made of copper or aluminium, for example as described in Italian patent application number 102017000056945 filed on 25 May 2017 in the name of the same Applicant.

With reference to FIG. 1, it shows a perspective view of a winding stator 1 with bar conductors according to a first embodiment of the disclosure.

The stator 1 comprises a stator core 2 of metallic material having a cylindrical shape and further comprises a stator winding 3 formed by the connection in series of the plurality of bar conductors.

It can be seen that the stator 1 comprises an insertion side 1-1 (above with respect to the reading direction of FIG. 1) formed by portions of the bar conductors that are projecting with respect to the upper end of the stator core 3 and comprises a twisting side 1-2 (below with respect to the reading direction of FIG. 1) formed by the bent projecting portions of the legs of the bar conductors.

Each bar conductor is preformed into a “U” shape and therefore comprises a first rectilinear portion (hereinafter referred to as “first leg”) and a second rectilinear portion (hereinafter referred to as “second leg”), which are electrically connected together by an arc-shaped portion defined hereinafter as “connecting element”.

In particular, for each conductor, “first leg” is defined as the one inserted into the slot of a radially innermost layer with respect to the layer of the slot in which the “second leg” is inserted.

The cross-section of the bar conductors is typically rectangular or square.

The stator winding 3 is formed by inserting the preformed bar conductors into the slots of the stator core at the insertion side and by suitably bending the projecting free ends of the legs of the bar conductors at the twisting side, thereby making suitable welds between the adjacent bent ends so as to electrically connect in series the desired number of bar conductors.

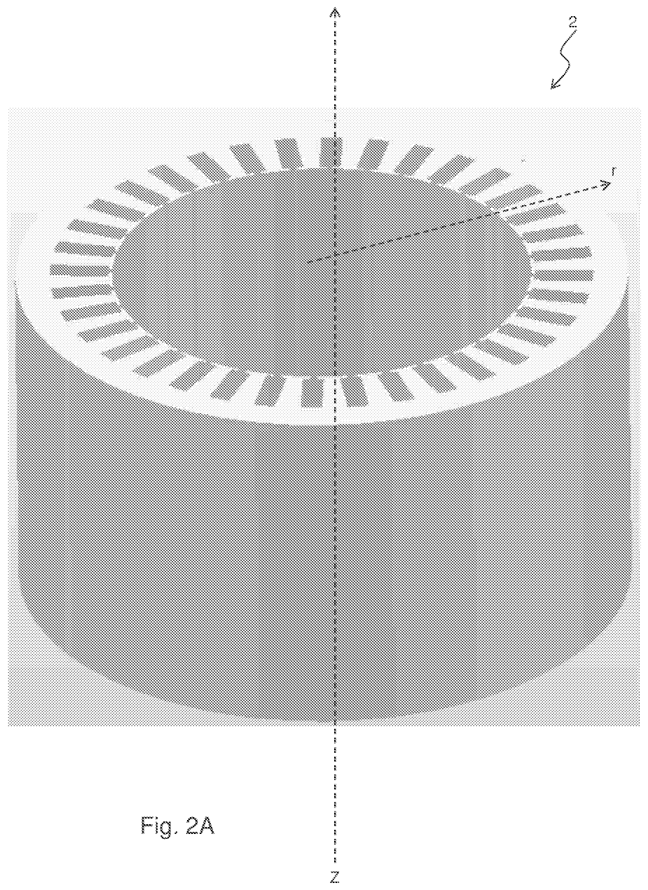

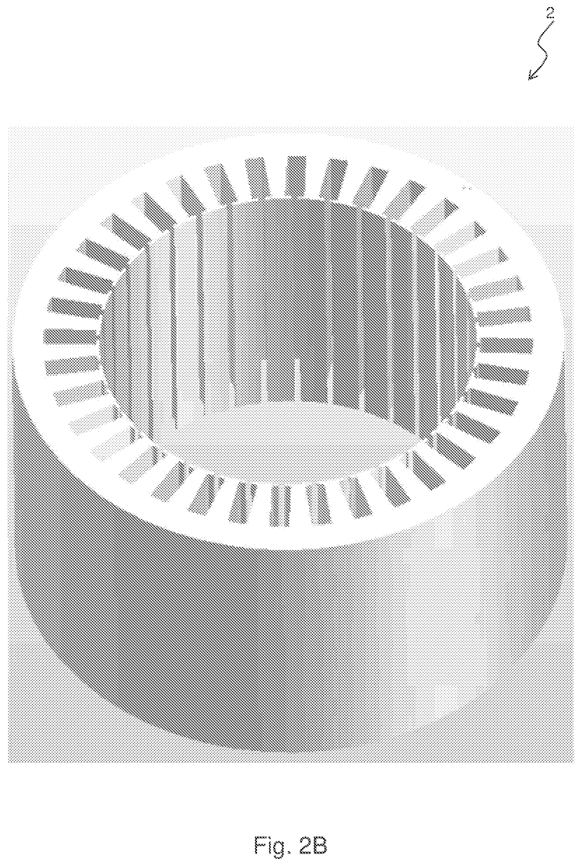

With reference to FIGS. 2A and 2B, the stator core 2 of the stator 1 is shown in more detail.

The stator core 2 has a cylindrical shape having a main extension defining an axial direction Z along the axis of the cylinder and having a secondary extension defining a radial direction r along the radius of the cylinder (see FIG. 2A).

The stator core 2 comprises a first face defining the insertion side 1-1 of the stator 1 and comprises a second face defining the twisting side 1-2 of the stator 1, wherein the first face is opposite to the second face along the axial direction Z.

The stator core 2 further comprises 36 rectilinear slots extending along the axial direction between the first face and the second face of the stator core 2.

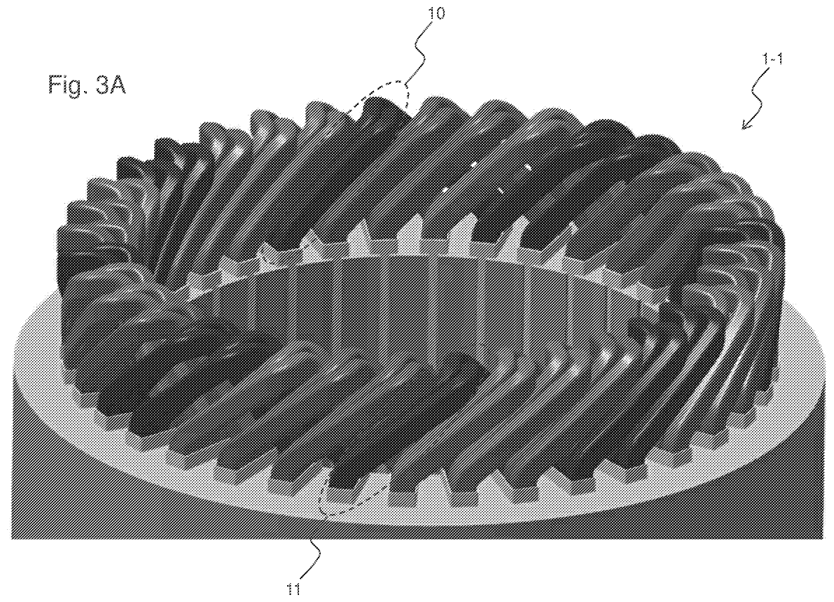

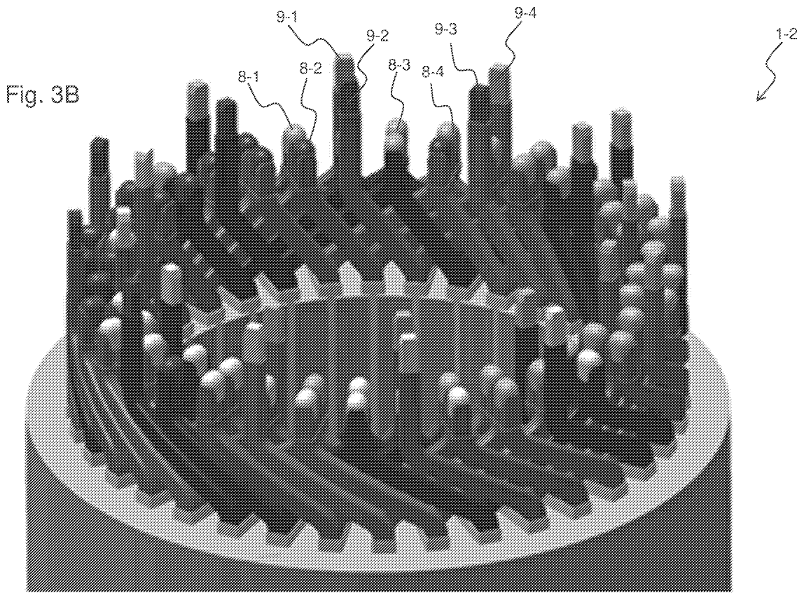

With reference to FIG. 3A, the projecting portion of the stator winding 1 at the insertion side 1-1 is shown in more detail.

In particular, the projecting portion at the insertion side is formed by a plurality of connecting elements, wherein each connecting element is adapted to connect an end of a first straight leg of a bar conductor with an end of a second straight leg of the same bar conductor.

The projecting portion at the insertion side is therefore formed by a plurality of connecting elements which are arranged side-by-side one another in the circumferential direction of the stator core 2.

It can be seen that the projecting portion at the insertion side is formed by a crown of connecting elements, wherein the connecting elements of the bar conductors are arranged in groups of two connecting elements arranged side-by-side; in particular, FIG. 3A shows a first group 10 composed of two bar conductors and a second group 11 composed of two bar conductors.

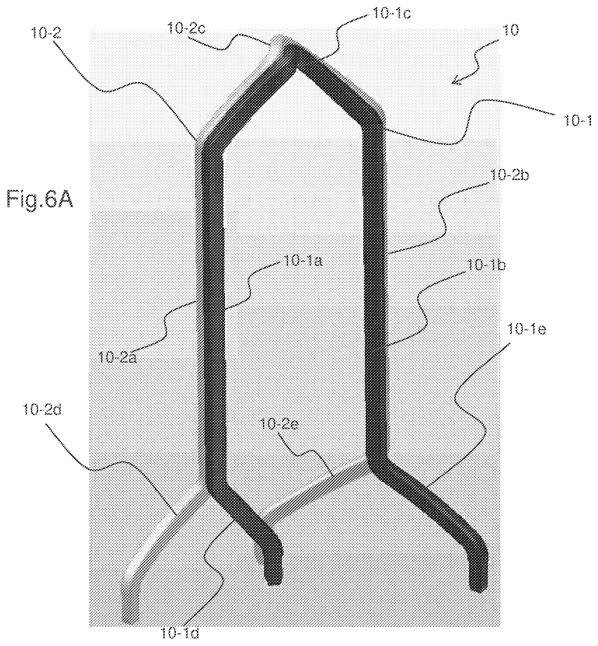

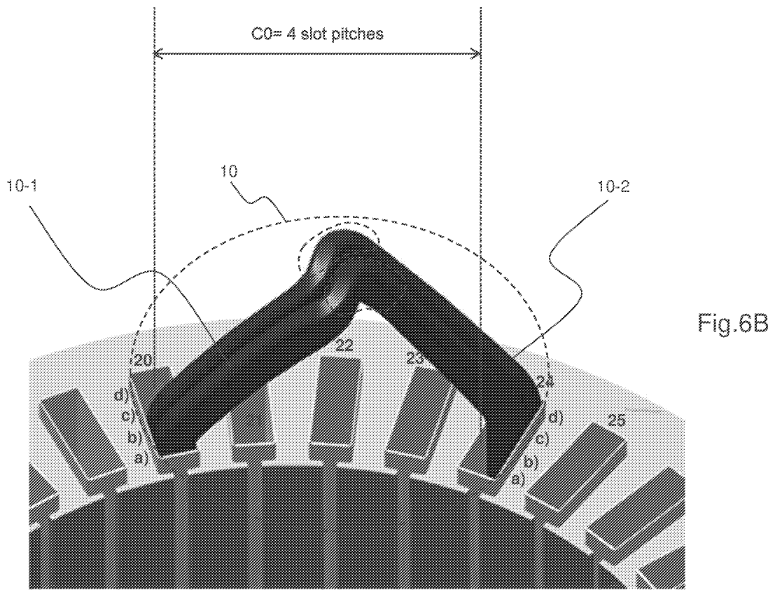

In particular, the bar conductors are arranged in groups composed of two bar conductors arranged side-by-side along the radial direction of a slot (see also FIG. 6B), i.e.:
the first leg of the first conductor of the group 10 is arranged side-by-side (i.e. adjacent) to the first leg of the second conductor of the group 10 in a same slot;
the second leg of the first conductor of the group 10 is arranged side-by-side (i.e. adjacent) to the second leg of the second conductor of the group 10 in a same slot;
the first leg of the first conductor of group 11 is arranged side-by-side (i.e. adjacent) to the first leg of the second conductor of group 11;
the second leg of the first conductor of group 11 is arranged side-by-side (i.e. adjacent) to the second leg of the second conductor of group 11.

With reference to FIG. 3B, the projecting portion of the bent legs forming the stator winding 1 at the twisting side 1-2 is shown in more detail.

It can be seen that there are a plurality of pairs of projecting portions of bent legs that are welded together (some welding points are indicated with 8-1, 8-2, 8-3. 8-4), wherein each pair comprises a bent projecting portion of one leg that is inserted into a slot at one layer radially adjacent to the layer in which, in another slot, the leg of the other bent projecting portion of the pair in question is located.

It is also possible to observe that the legs inserted into the same layer have projecting portions that are all twisted in the same circumferential direction.

Furthermore, it can be noted that the legs of one layer have the projecting portions that are all twisted in the same circumferential direction which is opposite to the circumferential twisting direction of the projecting portions of the legs of an adjacent layer, so as to allow the electrical connection between projecting ends of legs which are in radially adjacent layers; in other words, two contiguous layers comprise projecting ends of legs which are twisted in opposite circumferential directions, so as to allow the electrical connection between the ends of the bent projecting portions of legs inserted into adjacent layers.

For example, considering a top view of the twisting side, the projecting portions of the legs of the outermost layer are all twisted in the clockwise circumferential direction and the projecting portions of the legs of the layer contiguous to the outermost layer are all twisted in the counterclockwise circumferential direction: this facilitates the electrical connection between a projecting portion of a leg of the outermost layer with a projecting portion of a leg of the layer contiguous to the outermost layer.

Note that FIG. 3B shows only one twisting example and that embodiments are possible in which the legs of two adjacent layers have projecting portions that are all twisted in the same circumferential direction, or the legs of one layer have projecting portions that are not bent.

Finally, in FIG. 3B it can be seen that there are a plurality of bent projecting portions of legs (indicated with 9-1, 9-2, 9-3, 9,4) that are not electrically connected, as they are the beginning or the end of a respective parallel path: the final stator winding is obtained by connecting together the initial end of each parallel path of each phase, while the final ends of the different parallel paths are connected based on the type of winding desired (for example, like a star or triangle).

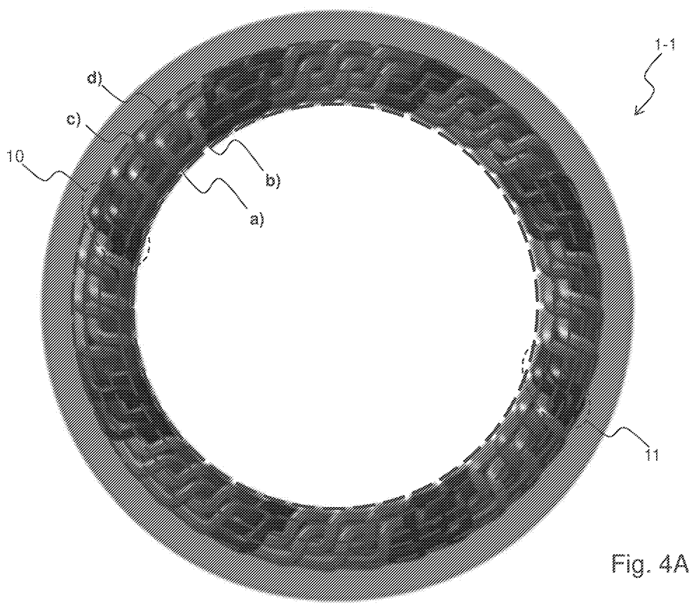

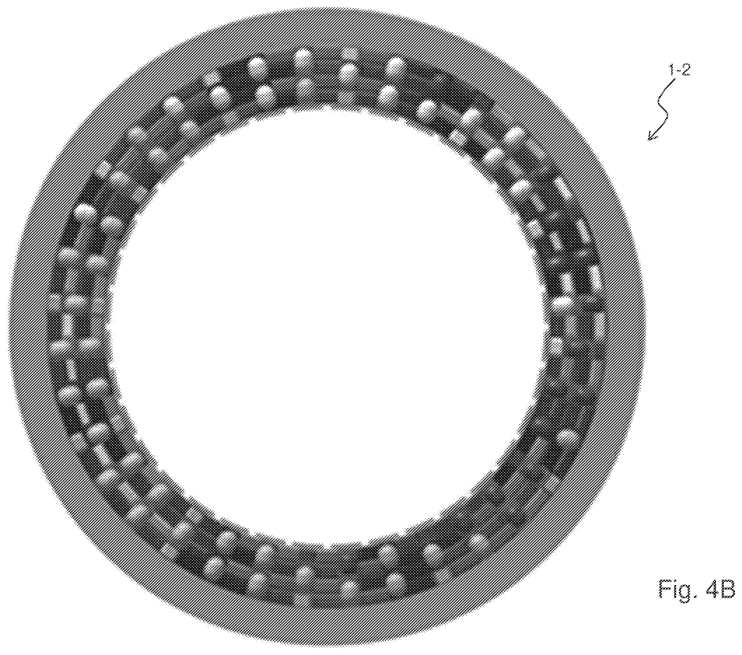

With reference to FIG. 4A, a top view of the insertion side of the stator of the first embodiment is shown.

It can be seen that the insertion side comprises a plurality of groups of two bar conductors which are arranged side-by-side one another so as to form a crown.

In particular, the same groups 10, 11 of FIG. 3A are shown in FIG. 4A.

It is also possible to observe that the two legs of the bar conductors, inserted into the slots of the stator core, define four concentric layers of legs indicated with the reference numbers a), b), c), d), in which the layer a) is the innermost and the layer d) is the outermost.

With reference to FIG. 4B, a top view of the twisting side of the stator of the first embodiment is shown.

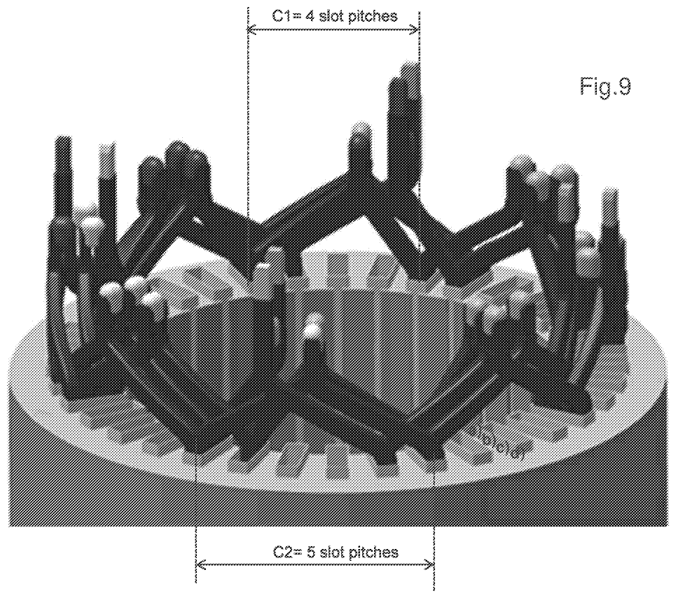

It can be seen that the twisting side comprises a plurality of terminal elements formed by the electrical connection by welding between two bent projecting ends of the two radially adjacent legs of two different bar conductors, so as to form two concentric circular layers of terminal elements, as will be explained in more detail below with reference to the description of FIGS. 9, 10, 11A-11F.

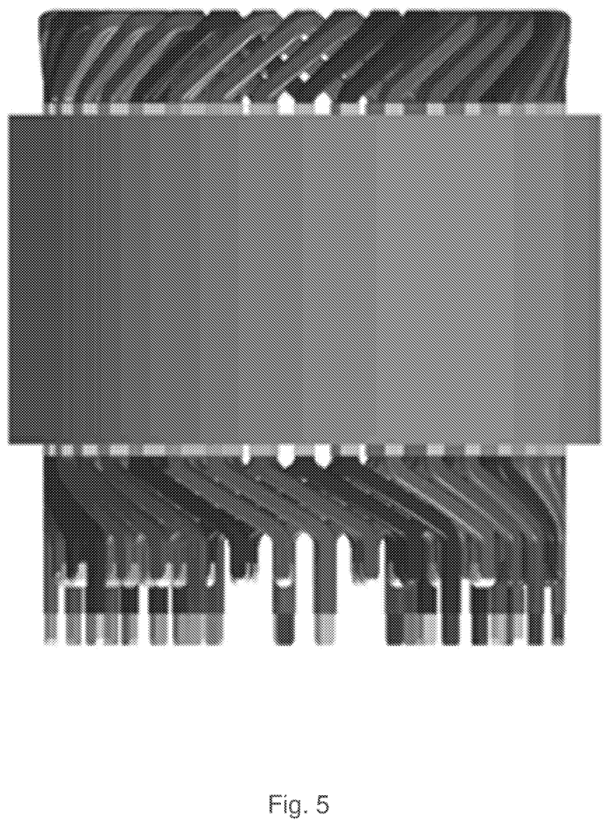

With reference to FIG. 5, a side view of the winding stator 1 with bar conductors of the first embodiment is shown.

It can be seen that the stator 1 is formed by the stator core 2 and by a stator winding formed by the connection of bar conductors having a projecting portion at the insertion side so as to form a crown and having another projecting portion at the twisting side formed by the electrical connection of the bent free ends of the legs of the bar conductors.

With reference to FIGS. 6A and 6B, there is shown a group 10 of bar conductors composed of two bar conductors 10-1, 10-2 arranged side-by-side according to the first embodiment, wherein FIG. 6A shows the group 10 of bar conductors isolated and FIG. 6B shows the same group 10 of conductors inserted into the stator core 2, but isolated with respect to the remaining groups of conductors of the crown of FIG. 3A.

The bar conductor 10-1 (indicated with a darker shade) comprises a first leg, a second leg and a connecting element 10-1c adapted to electrically connect the first leg with the second leg at the insertion side.

The first leg of the bar conductor 10-1 comprises a straight portion 10-1a and a further projecting portion 10-1d forming a first free end of the first leg, wherein the portion 10-1d also comprises a stretch of substantially straight conductor that is bent with respect to the straight portion 10-1a; for example, the angle formed between the direction defined by the straight portion 10-1a and the direction defined by the straight stretch 10-1d is comprised between 100 and 170 degrees.

Similarly, the second leg of the bar conductor 10-1 comprises a straight portion 10-1b and a further projecting portion 10-1e forming a second free end of the second leg, wherein the portion 10-1e also comprises a stretch of substantially straight conductor that is bent with respect to the straight portion 10-1b; for example, the angle formed between the direction defined by the straight portion 10-1b and the direction defined by the straight stretch 10-1e is comprised between 100 and 170 degrees.

The connecting member 10-1c is adapted to electrically connect at the insertion side the straight portion 10-1a of the first leg with the straight portion 10-1b of the second leg.

The connecting element 10-1c further has an arc shape that allows to insert the second leg 10-1b of the conductor 10-1 into a layer that is in a radial position different from the one of the layer in which the first leg 10-1a of the conductor 10-1 is inserted.

In one embodiment, the arc shape of the connecting member 10-1c is (seen from above) of the “S” type.

The above considerations relating to the bar conductor 10-1 are applicable similarly to the bar conductor 10-2 (lighter shade in FIG. 6A), i.e. it also comprises a first leg having a straight portion 10-2a and a first free end 10-2d, a second leg having a straight portion 10-2b and a second free end 10-2e and a connecting element 10-2c between the straight portion 10-2a of the first leg and the straight portion 10-2b of the second leg.

FIG. 6B shows a portion of the stator 1 at the insertion side, wherein the stator core 2 comprises six slots indicated with the progressive numbers 20, 21, 22, 23, 24, 25, and wherein each slot is composed of four layers indicated with the letters a), b), c), d) and adapted to contain four straight legs of two bar conductors, wherein the layer a) is the innermost in the radial direction and the layer d) is the outermost.

The group of conductors 10 is composed of the two bar conductors 10-1, 10-2 arranged side-by-side in the radial direction, i.e.:
the bar conductor 10-1 comprises a first leg inserted into the layer a) of the slot number 20 and comprises a second leg inserted into the layer c) of the slot number 24, therefore the first leg of the conductor 10-1 is inserted into a layer that is in a radial position different from the layer in which the second leg of the same conductor 10-1 is inserted (in particular, the first leg in the layer a) is radially more internal than the second leg in the layer c));
the bar conductor 10-2 comprises a first leg inserted into the layer b) of the slot number 20 and comprises a second leg inserted into the layer d) of the slot number 24, therefore the first leg of the conductor 10-2 is inserted into a layer that is in a radially different position from the layer in which the second leg of the same conductor 10-2 is inserted (in particular, the first leg in the layer b) is radially more internal than the second leg in the layer d)).

The first leg of the bar conductor 10-1 is arranged side-by-side to the first leg of the bar conductor 10-2, as the first leg of the bar conductor 10-1 is inserted into the layer a) of the slot number 20 and the first leg of the bar conductor 10-2 is inserted into the layer b) of the same slot number 20.

Similarly, the second leg of the bar conductor 10-1 is arranged side-by-side to the second leg of the bar conductor 10-2, as the second leg of the bar conductor 10-1 is inserted into the layer c) of the slot number 24 and the second leg of the bar conductor 10-2 is inserted into the layer d) of the same slot number 24.

It can be seen in FIG. 6B that the radial distance between the layer of the first leg of the bar conductor 10-1 and the layer of the second leg of the same conductor 10-1 is equal to 2 layers, that is, it is precisely equal to the number of the conductors forming the group 10.

In fact, the first leg of the conductor 10-1 is inserted into the layer a) of the slot number 20 and the second leg of the conductor 10-1 is inserted into the layer c) of the slot number 24, therefore the radial distance between the layer a) and the layer c) is equal to two, i.e. the number of the conductors of the group 10.

Similarly, the radial distance between the layer of the first leg of the bar conductor 10-2 and the layer of the second leg of the same conductor 10-2 is equal to 2 layers, i.e. it is precisely equal to the number of the conductors forming the group 10.

In fact, the first leg of the conductor 10-2 is inserted into the layer b) of the slot number 20 and the second leg of the conductor 10-2 is inserted into the layer d) of the slot number 24, therefore the radial distance between the layer b) and the layer d) is equal to two, which is the number of the conductors of the group 10.

It can also be observed that the distance C0 in the circumferential angular direction (measured in slot pitches) between the slot in which the first leg of the conductor 10-1 is inserted (i.e. the leg inserted into the slot number 20) and the slot in which the second leg of the same conductor 10-1 is inserted (i.e. the leg inserted into the slot number 24) is equal to four slot pitches, which is a defined value that is chosen during the design phase of the winding 3.

Similarly, the distance C0 in the circumferential angular direction between the slot in which the first leg of the conductor 10-2 is inserted (i.e. the leg inserted into slot number 20) and the slot in which the second leg of the same conductor 10-2 is inserted (i.e. the leg inserted into slot number 24) is equal to four slot pitches.

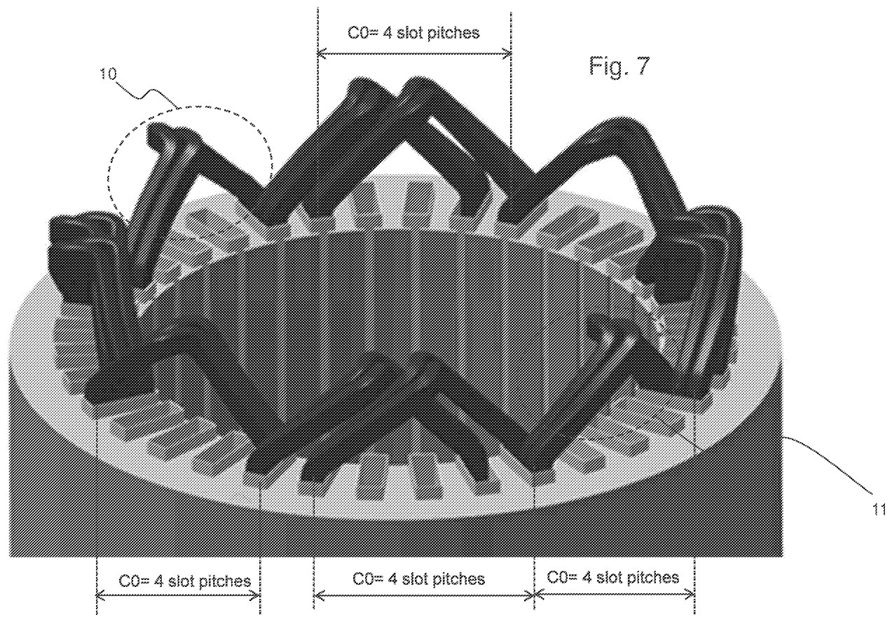

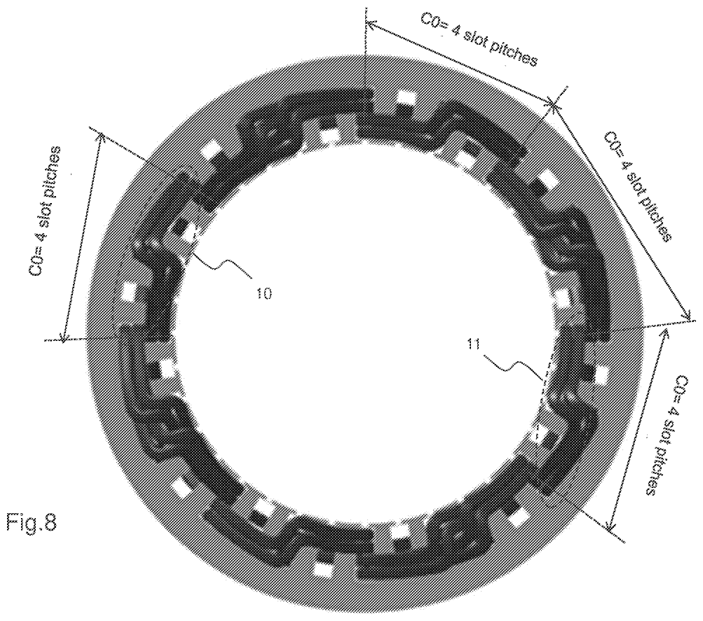

With reference to FIGS. 7 and 8, there is shown a perspective and top view of 12 groups of bar conductors at the insertion side of the stator 1, each composed of two bar conductors similar to the conductors 10-1, 10-2 of FIGS. 6A-6B.

In particular, the same groups 10, 11 of FIG. 3A are shown in FIG. 7.

It can be observed for each group that the circumferential distance C0 between the slots in which the two legs of the same bar conductor are inserted is equal to four slot pitches.

Finally, it can be observed that for each bar conductor of the group the radial distance between the two legs is equal to two layers, that is, it is equal to the number of the conductors that compose each group.

With reference to FIG. 9, a perspective view of the 12 groups of bar conductors of FIGS. 7 and 8 at the twisting side is shown.

It can be seen that there are pairs of projecting portions of the two legs of two different bar conductors which are connected together by twisting the free ends of the two legs bent in the opposite direction in the circumferential direction, i.e. a projecting portion of a leg of a bar conductor is bent clockwise and the projecting portion of a radially adjacent leg of another bar conductor is bent counterclockwise, or vice versa.

It is also possible to observe that the value of the twisting angle (expressed in slot pitches) of the projecting portions of the legs is homogeneous within the single layer, that is:
the twisting angle of the projecting portions of the legs inserted into the layer a) (i.e. the radially innermost one) is equal to 1.5 slot pitches counterclockwise;
the twisting angle of the projecting portions of the legs inserted into the layer b) (contiguous to the layer a)) is equal to 2.5 slot pitches clockwise;
the twisting angle of the projecting portions of the legs inserted into the layer c) (contiguous to the layer b)) is equal to 2.5 slot pitches counterclockwise;
the twisting angle of the projecting portions of the legs inserted into the layer d) (i.e. the radially outermost one) is equal to 2.5 slot pitches clockwise.

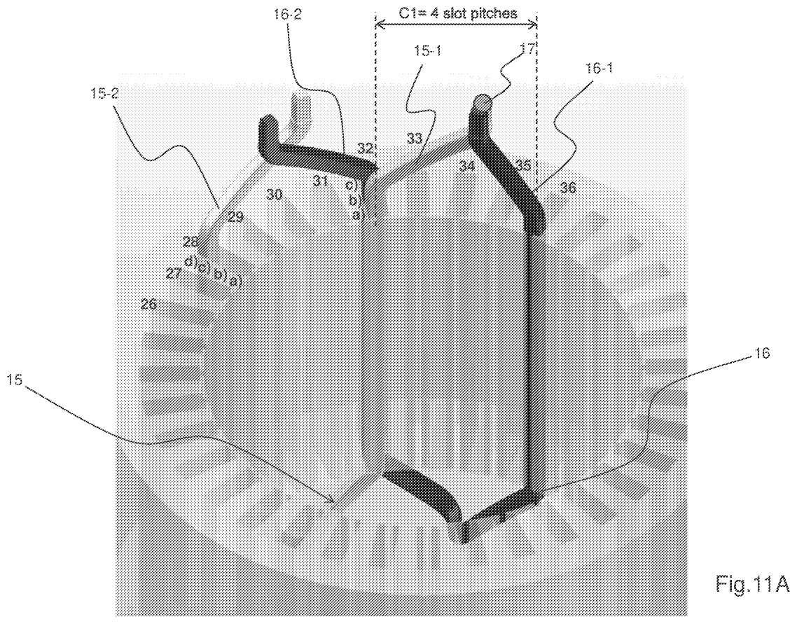

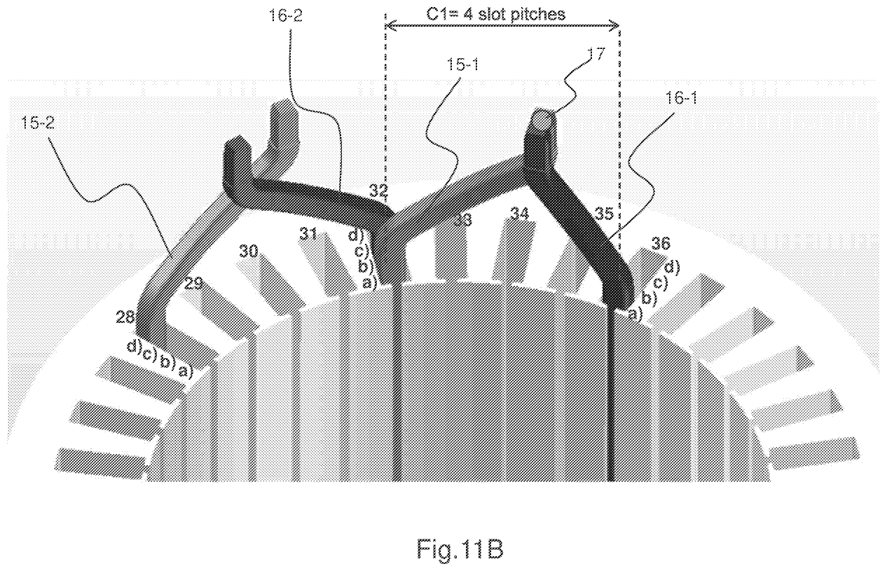

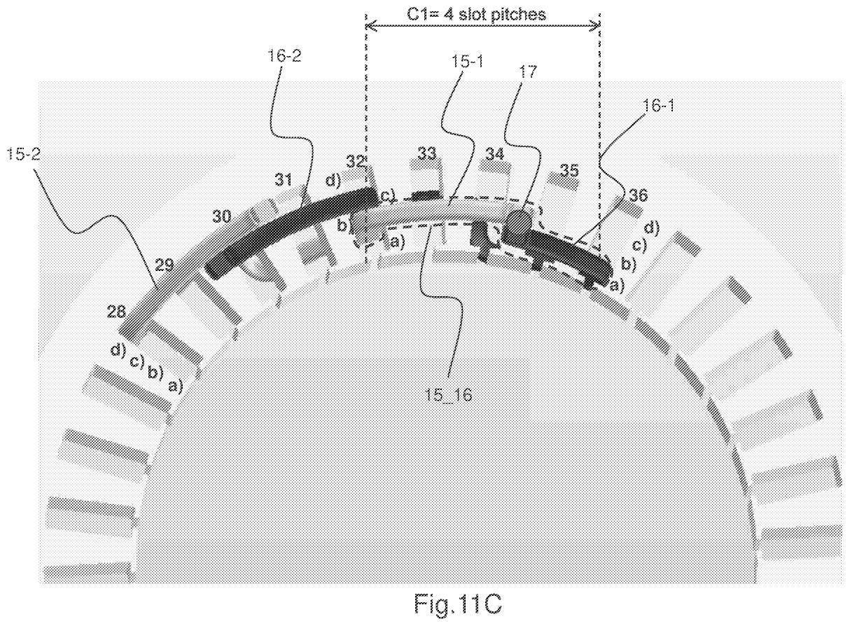

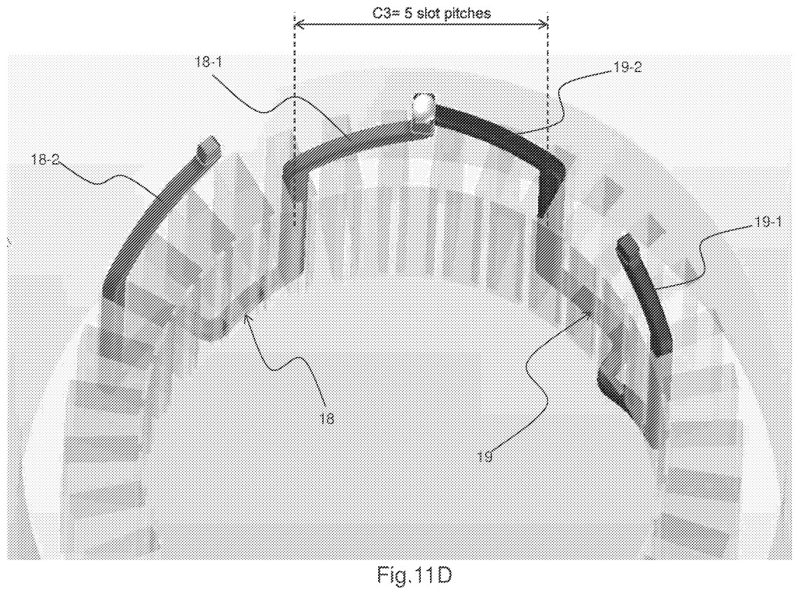

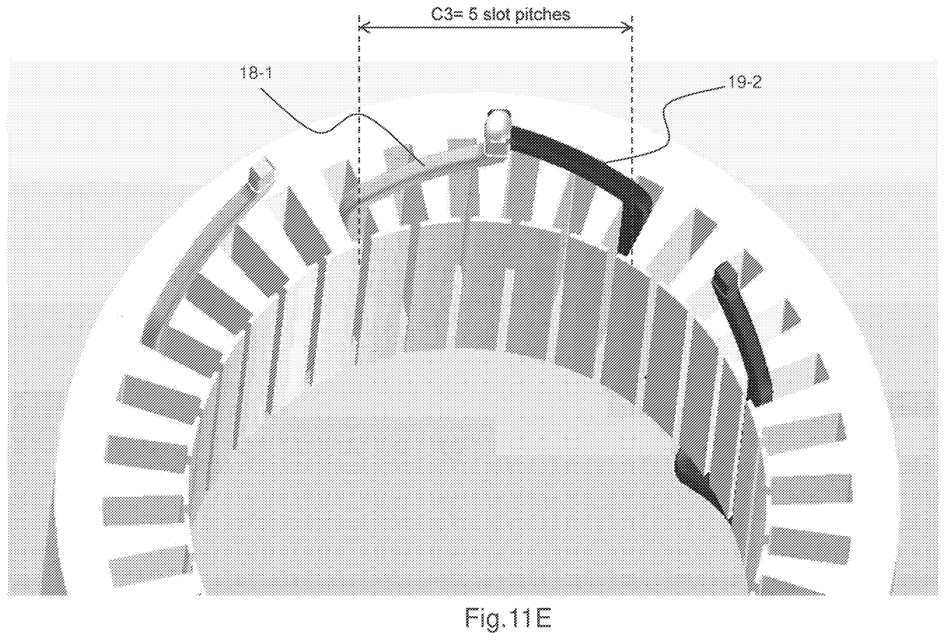

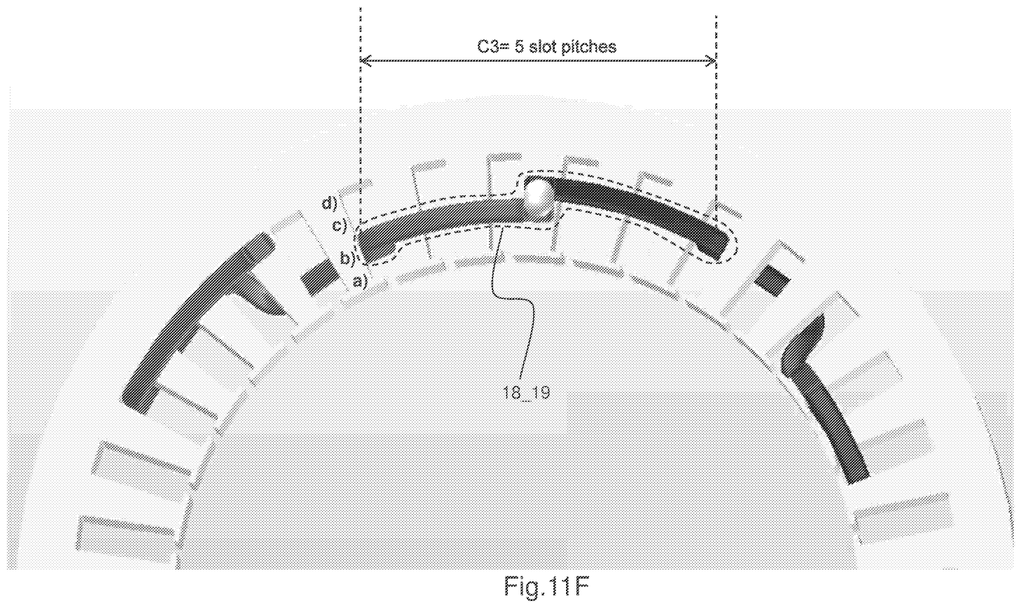

Finally, it can be seen that a first circumferential distance C1 is equal to four slot pitches and is equal to the value of the circumferential distance C0 between the two legs of a conductor of a group at the insertion side, wherein C1 is the distance between the slot in which the first leg connected to a bent projecting portion of a bar conductor is inserted and the slot in which the first leg connected to a bent projecting portion of another bar conductor is inserted, as will be explained in more detail below with reference to the description of FIGS. 11A-11C.

Otherwise, a second circumferential distance C2 is equal to five slot pitches and is different from the value of the circumferential distance C0 between the two legs of a conductor of a group at the insertion side, wherein C2 is the distance between the slot in which the second leg connected to a bent projecting portion of a bar conductor is inserted and the slot in which the second leg connected to a bent projecting portion of another bar conductor is inserted, as will be explained in more detail later.

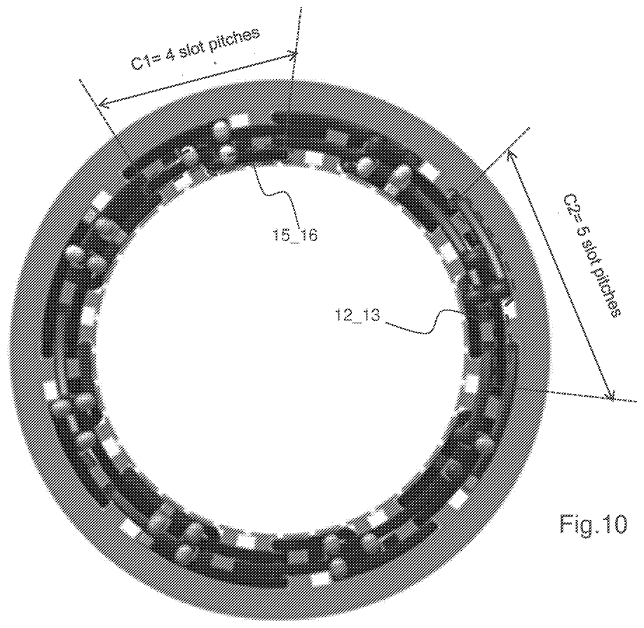

With reference to FIG. 10, a top view of the 12 groups of bar conductors of FIG. 9 is shown at the twisting side.

It can be seen that the twisting side comprises a plurality of terminal elements (for simplicity's sake two terminal elements with the reference numerals 15_16 and 12_13 have been indicated with a closed dashed line) formed by the electrical connection by welding the bent projecting portions of the radially adjacent legs of two different bar conductors, as will be explained in more detail below with reference to the description of FIGS. 11A-11F.

It is also possible to observe that the value of a first circumferential distance C1 associated with a first terminal element 15_16 (which will be defined later) is equal to four slot pitches, i.e. C1 is equal to the value of the circumferential distance C0 between the two legs of a conductor of a group at the insertion side; otherwise, the value of a second circumferential distance C2 associated with a second terminal element 12_13 (which will be defined later) is equal to five slot pitches, i.e. C2 is different from C0.

FIG. 11A shows a perspective view of a portion of the stator 1 at the twisting side and FIG. 11B shows in more detail the same portion of FIG. 11A, wherein the stator core 2 comprises a plurality of slots indicated with the progressive numbers 26, 27, 28, 29, 30, 31, 32, 33, 34, 35, 36, and wherein each slot is composed of four layers indicated with the letters a), b), c), d), similarly to FIG. 6B.

In particular, FIG. 11A shows a bar conductor 15 (indicated with a lighter shade) and another bar conductor 16 (indicated with a darker shade), which are inserted into the stator core 2, in which the connecting elements at the insertion side are visible and the projecting portions of the legs of the bar conductors 15 and 16 are visible at the twisting side.

For the purpose of explaining the disclosure the bar conductors 15 and 16 have been shown isolated from the remaining bar conductors shown in FIG. 3B.

FIG. 11B instead shows in more detail the projecting portions of the bar conductors 15 and 16 at the twisting side.

FIG. 11C shows a top view of the bar conductors 15 and 16 at the twisting side, in particular a top view of the bent projecting portions of the legs of the bar conductors 15, 16.

In particular, the bent projecting portions 15-1, 15-2 of the bar conductor 15 and the bent projecting portions 16-1, 16-2 of the bar conductor 16 are shown, wherein:
the bar conductor 15 comprises a first portion 15-1 that is projecting with respect to the stator core 2 at the twisting side, in particular it is the bent projecting portion 15-1 of a first leg inserted into the layer b) of the slot number 32, wherein the first projecting portion 15-1 is twisted in a circumferential direction clockwise with respect to the plane defined by the end of the stator core 2 at the twisting side;
the bar conductor 15 comprises a second portion 15-2 that is projecting with respect to the stator core 2 at the twisting side, in particular it is the bent projecting portion 15-2 of a second leg inserted into the layer d) of the slot number 28, wherein the second projecting portion 15-2 is twisted in a circumferential direction clockwise with respect to the plane defined by the end of the stator core 2 at the twisting side;
the bar conductor 16 comprises a first portion 16-1 that is projecting with respect to the stator core 2 at the twisting side, in particular it is the bent projecting portion 16-1 of a first leg inserted into the layer a) of the slot number 36, wherein the first projecting portion 16-1 is twisted in a circumferential direction counterclockwise with respect to the plane defined by the end of the stator core 2 at the twisting side;
the bar conductor 16 comprises a second portion 16-2 which is projecting with respect to the stator core 2 at the twisting side, in particular it is the bent projecting portion 16-2 of a second leg inserted into the layer c) of the slot number 32, wherein the second projecting portion 16-2 is twisted in a circumferential direction counterclockwise with respect to the plane defined by the end of the stator core 2 at the twisting side.

It can be seen that the end of the bent projecting portion 15-1 of the first leg of the bar conductor 15 is electrically connected (by means of the weld 17) with the end of the bent projecting portion 16-1 of the first leg of the bar conductor 16 and this is possible for the following reasons:
the bent projecting portions 15-1 and 16-1 are connected to the respective first legs which are inserted into radially adjacent layers, since the projecting portion 15-1 is connected to the first leg (of the conductor 15) which is inserted into the layer b) of the slot 32 and the projecting portion 16-1 is connected to the first leg (of the conductor 16) which is inserted into the layer a) of the slot 36, wherein the layers b) and a) are adjacent to each other (i.e. no other layer is interposed between them);
a twisting of the projecting portion of the first leg of the bar conductor 15 and a twisting of the projecting portion of the first leg of the bar conductor 16 has been carried out so as to approach (to the limit until touching one another) the end of the bent projecting portion 15-1 with the end of the bent projecting portion 16-1;
a weld 17 is applied between the end of the bent projecting portion 15-1 and the end of the bent projecting portion 16-1 so as to make an electrical connection therebetween.

In particular, the bent projecting portion 15-1 was twisted by 2.5 slot pitches in a clockwise circumferential direction and the bent projecting portion 16-1 was twisted by 1.5 slot pitches in a counterclockwise circumferential direction (see FIG. 11C), so that the respective ends are positioned side-by-side in the space, possibly until they are in contact with each other.

Furthermore, it can be seen that the bent projecting portion 15-1 is connected to the first leg of the bar conductor 15 which is inserted into a layer b) which is radially adjacent to the layer a) in which the first leg connected to the bent projecting portion 16-1 of the bar conductor 16 is inserted: this further facilitates the electrical connection between the two bent projecting portions 15-1, 16-1 and allows the electrical connection similarly to other pairs of projecting ends of the first legs of other surrounding bar conductors and to other pairs of projecting ends of the second legs of other surrounding bar conductors.

The assembly of the electrical connection between the bent projecting portion 15-1 of the first leg of the bar conductor 15 and the bent projecting portion 16-1 of the first leg of the bar conductor 16 defines at the twisting side (see FIGS. 10 and 11C) a terminal element 15_16 associated with the bar conductors 15 and 16 at the twisting side, which will be referred to below as “first terminal element” 15_16 as it electrically connects the bent projecting ends of the first legs of two different bar conductors at the twisting side.

It can also be observed that the first distance C1 in the circumferential angular direction (measured in slot pitches) between the slot in which the first leg connected to the bent projecting end 15-1 of the conductor 15 is inserted and the slot in which the first leg connected to the bent projecting end 16-1 of the other conductor 16 is inserted is equal to four slot pitches, which is therefore equal to the defined distance C0 at the insertion side between the two legs of the bar conductors 10-1, 10-2 of the group 10.

The above considerations relating to the bar conductors 15, 16 of FIGS. 11A-11C are similarly applicable to further pairs of bar conductors at the twisting side, with the difference that each pair of bar conductors has the two second legs that are radially adjacent, and furthermore for each pair of conductors the bent projecting portion of the second leg of one conductor is electrically connected with the bent projecting portion of the second leg of the other conductor.

The assembly of the electrical connection between the bent projecting portion of the second leg of a bar conductor and the bent projecting portion of the second leg of the other bar conductor of the same pair defines at the twisting side a “second terminal element” (indicated in FIG. 10 with reference number 12_13), as this electrically connects the projecting ends of the second legs of two different bar conductors at the twisting side.

In this case a second distance C2 (see FIGS. 9 and 10) is defined in the circumferential angular direction (measured in slot pitches) between the slot in which the second leg connected to the projecting conductor end of a pair is inserted and the slot in which the second leg connected to the projecting end of the other conductor 19 of the same pair is inserted.

According to the first embodiment shown in FIGS. 1-11F, the circumferential distance C0 (4 slot pitches) at the insertion side between the two legs of the bar conductors 10-1, 10-2 of the group 10 is equal to the first circumferential distance C1 (4 slot pitches) at the twisting side between the slots in which the first legs of the first terminal element 15_16 are inserted, while the circumferential distance C0 (4 slot pitches) at the insertion side is different from the second circumferential distance C2 (5 slot pitches) at the twisting side between the slots in which the second legs of the second terminal element 12_13 are inserted.

Alternatively, the circumferential distance C0 at the insertion side between the two legs of the bar conductors 10-1, 10-2 of the group 10 is different from the first circumferential distance C1 at the twisting side between the slots in which the first legs of the first terminal element 15_16 are inserted, while the circumferential distance C0 at the insertion side is equal to the second circumferential distance C2 at the twisting side between the slots in which the second legs of the second terminal element 12_13 are inserted.

According to a variant of the first embodiment of the disclosure (not shown in the Figures), the circumferential distance C0 at the insertion side between the two legs of the bar conductors 10-1, 10-2 of the group 10 is both equal to the first circumferential distance C1 at the twisting side between the slots in which the first legs of the first terminal element 15_16 are inserted, and equal to the second circumferential distance C2 at the twisting side between the slots in which the second legs of the second terminal element 12_13 are inserted: for example, the value of the distances C0, C1, C2 is equal to 4 slot pitches.

According to the first embodiment, the stator 1 comprises a stator core 2 having a first face defining an insertion side 1-1 and a second face defining a twisting side 1-2, wherein the first face is opposite to the second one with respect to an axial direction defined by a main extension of the stator core, the stator core comprising a plurality of slots (similar to 20, 21, 22, 23, 24) extending along the axial direction of the stator core between the first face and the second face.

The stator winding 3 comprises a plurality of bar conductors (similar to the conductors 10-1, 10-2) connected together in series to form the stator winding, each bar conductor comprising a first leg (similar to 10-1a for the conductor 10-1, 10-2a for the conductor 10-2) and a second leg (similar to 10-1b for the conductor 10-1, 10-2b for the conductor 10-2) comprising respective portions inserted into different slots, comprises a connecting element (similar to 10-1c for the conductor 10-1, 10-2c for the conductor 10-2) adapted to electrically connect the first and second legs at the insertion side, comprises a first end (similar to 10-1d for the conductor 10-1, 10-2d for the conductor 10-2) of the first leg projecting with respect to the second face of the stator core and comprises a second stator end (similar to 10-1e for the conductor 10-1, 10-2e for the conductor 10-2) of the projecting leg.

Each slot comprises a plurality of first and/or second legs of different bar conductors arranged side-by-side along a radial direction of the stator core defined by the secondary extension of the stator core, so as to define a plurality of layers of legs that are concentric with respect to the axial direction of the stator core.

The plurality of bar conductors is arranged at the insertion side in groups (similar to 10 and 11) comprising at least two bar conductors having the respective first legs arranged side-by-side along the radial direction of a slot and having the respective second legs arranged side-by-side along the radial direction of another slot.

For each group of the plurality of bar conductors, the layer of the first leg of a conductor is radially distant from the layer of the second leg of the same conductor by a defined quantity equal to the number of bar conductors of each group.

The stator winding 3 comprises at least one winding portion, each portion comprising a plurality of groups of bar conductors organised so that the first legs of different groups are inserted into the same layers (e.g., layers a), b) of FIG. 6B) of different slots and so that the second legs of different groups are inserted into the same layers (e.g., layers c), d) of FIG. 6B) of different slots.

Furthermore, for the groups of the plurality of bar conductors of each winding portion, the distance in the circumferential angular direction at the insertion side between the slot in which the first leg of each bar conductor is inserted and the slot in which the second leg of the same bar conductor is inserted is equal to the defined value C0 measured in slot pitches.

Each winding portion comprises a plurality of first terminal elements (similar to 15_16) at the twisting side each formed by the electrical connection between the first bent projecting end (similar to 15-1 per conductor 15) of the first leg of a bar conductor (similar to 15) and the first bent projecting end (similar to 16-1 per conductor 16) of the first leg of another bar conductor (similar to 16), wherein the layer in which the first leg having the first bent projecting end of said bar conductor is inserted is radially adjacent to the layer in which the first leg having the first bent projecting end of the other bar conductor is inserted.

For each first terminal element of said plurality, the first distance C1 measured in slot pitches is defined along the circumferential angular direction at the twisting side between the slot in which the first leg having the first projecting end of a bar conductor of the first terminal element of said plurality is inserted and the slot in which the first leg connected to the first projecting end of another bar conductor of the same first terminal element of said plurality is inserted.

Each stator winding portion further comprises a plurality of second terminal elements (similar to 12_13) at the twisting side each formed by the electrical connection between the second bent projecting end of the second leg of a bar conductor and the second bent projecting end of the second leg of another bar conductor, wherein the layer in which the second leg having the second bent projecting end of said bar conductor is inserted is radially adjacent to the layer in which the second leg having the second bent projecting end of the other bar conductor is inserted.

For each first terminal element of said plurality, the second distance C2 measured in slot pitches is defined along the circumferential angular direction at the twisting side between the slot in which the second leg having the second projecting end of a bar conductor of the second terminal element of said plurality is inserted and the slot in which the second leg connected to the second projecting end of another bar conductor of the same second terminal element of said plurality is inserted.

According to the first embodiment, at least one between the first distance C1 and the second distance C2 at the twisting side is equal to the value of the distance C0 at the insertion side.

FIGS. 11D, 11E, 11F show another pair of bar conductors 18 (indicated with a lighter shade) and 19 (indicated with a darker shade) which are inserted into the stator core 2 so as to have the first leg 18-1 of the conductor 18 that is radially adjacent to the second leg 19-2 of the conductor 19 (layer b) and c) respectively), wherein:
in FIG. 11D the connecting elements at the insertion side are visible and the projecting portions 18-1, 18-2 of the bar conductor 18 and the projecting portions 19-1, 19-2 of the bar conductor 19 at the twisting side are visible;
in FIG. 11E the projecting portions 18-1, 18-2 of the bar conductor 18 and the projecting portions 19-1, 19-2 of the bar conductor 19 at the twisting side are visible in more detail;
in FIG. 11F the top views of the bar conductors 18 and 19 at the twisting side, in particular a third terminal element 18_19 are visible.

The above considerations relating to the bar conductors 15, 16 of FIGS. 11A-11C are applicable similarly to the bar conductors 18, 19 of FIGS. 11D-11F, with the difference that the projecting portion 18-1 of the first leg of the bar conductor 18 is connected with the projecting portion 19-2 of the second leg of the bar conductor 19.

The assembly of the electrical connection between the projecting portion 18-1 of the first leg of the bar conductor 18 and the projecting portion 19-2 of the second leg of the bar conductor 19 defines at the twisting side (see FIG. 11F) a third terminal element 18_19 in that it electrically connects (at the twisting side) the projecting end of the first leg of a bar conductor of a pair of conductors with the projecting end of the second leg of the other bar conductor of the same pair.

It can be seen in FIGS. 11D-11F that the distance C3 in the circumferential angular direction (measured in slot pitches) between the slot in which the first leg connected to the projecting end 18-1 of the conductor 18 is inserted and the slot in which the second leg connected to the projecting end 19-2 of the other conductor 19 is inserted is equal to five slot pitches, which is therefore different from the circumferential distance C0 at the insertion side between the two legs of the bar conductors 10-1, 10-2 of the group 10.

Alternatively, the distance C3 may be equal to the circumferential distance C0 at the insertion side.

Note that in FIGS. 11D, 11E, 11F third terminal elements for connecting at the twisting side formed by the electrical connection of the projecting portion of the first leg of a bar conductor with the projecting portion of the second leg of another bar conductor have been considered, wherein the first leg of said bar conductor is radially adjacent to the second leg of the other bar conductor (in particular, the first leg is radially innermost with respect to the second leg).

According to other variants of the first embodiment, the following other values of the distances C0, C1, C2, measured in slot pitches, are possible:
the value of the defined distance C0 is equal to four, the value of the first distance C1 is equal to five and the value of the second distance C2 is equal to four;
the value of the defined distance C0 is equal to five, the value of the first distance C1 is equal to four and the value of the second distance C2 is equal to five;
the value of the defined distance C0 is equal to seven, the value of the first distance C1 is equal to eight and the value of the second distance C2 is equal to seven;
the value of the defined distance C0 is equal to eight, the value of the first distance C1 is equal to seven and the value of the second distance C2 is equal to eight;
the value of the defined distance C0 is equal to ten, the value of the first distance C1 is equal to eleven and the value of the second distance C2 is equal to ten;
the value of the defined distance C0 is equal to eleven, the value of the first distance C1 is equal to ten and the value of the second distance C2 is equal to eleven.

According to a further variant of the first embodiment, the stator winding 3 comprises at least one winding portion comprising at least one further first terminal element at the twisting side, each formed by the electrical connection between the first bent projecting end of the first leg of a bar conductor and the first bent projecting end of the first leg of another bar conductor, wherein the layer in which the first leg having the first bent projecting end of said bar conductor is inserted is adjacent to the layer in which the first leg having the first bent projecting end of the other bar conductor is inserted.

For each additional first terminal element of the plurality, there is defined a further first distance C1′ measured in slot pitches along the circumferential angular direction at the twisting side between the slot in which the first leg having the first projecting end of a bar conductor of the further first terminal element is inserted and the slot in which the first leg having the first projecting end of the other bar conductor of the same further first terminal element is inserted, wherein the further first distance C1′ is different from the first distance C1. For example, the distance C1 is equal to 4 slot pitches and the distance C1′ is equal to 5 slot pitches.

Alternatively (or in combination with the above further first terminal element), the stator winding 3 comprises at least one winding portion comprising at least one further second terminal element at the twisting side, each formed by the electrical connection between the second bent projecting end of the second leg of a bar conductor and the second bent projecting end of the second leg of another bar conductor, wherein the layer in which the second leg having the second bent projecting end of said bar conductor is inserted is adjacent to the layer in which the second leg having the second bent projecting end of the other bar conductor is inserted.

For each further second terminal element of the plurality, there is defined a further second distance C2′ measured in slot pitches along the circumferential angular direction at the twisting side between the slot in which the second leg having the second projecting end of a bar conductor of the further second terminal element is inserted and the slot in which the second leg having the second projecting end of the other bar conductor of the further second terminal element is inserted, wherein the further second distance C2′ is different from the second distance C2.

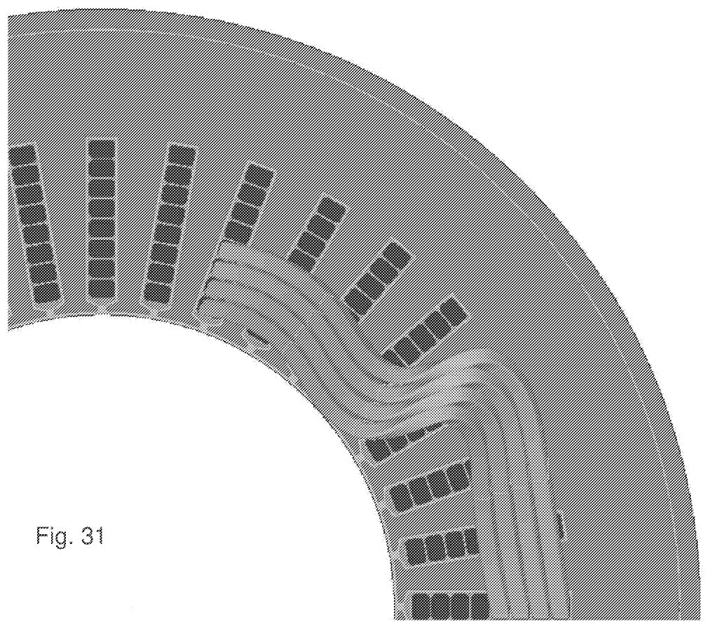

Note that for the purpose of the explaining the disclosure, a first embodiment has been considered in which the bar conductors are arranged at the insertion side in groups of two bar conductors, but the disclosure can also be applied to bar conductors arranged in groups of four bar conductors as shown in FIG. 31.

More generally, the bar conductors can be arranged at the insertion side in groups containing a number K of side-by-side bar conductors that is equal to half the number L of layers of the stator winding (i.e. K=L/2) or is equal to a sub-multiple of half the number of layers L (i.e. K is a sub-multiple of L/2).

For example, if the number of the layers of the stator winding is L=8, each group of bar conductors may contain K=4 or K=2 side-by-side bar conductors.

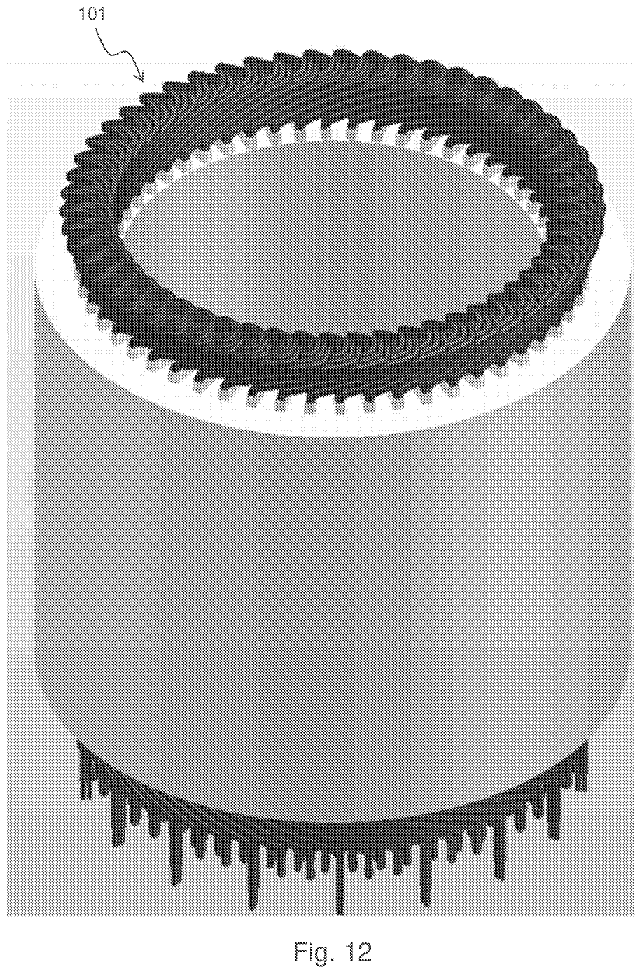

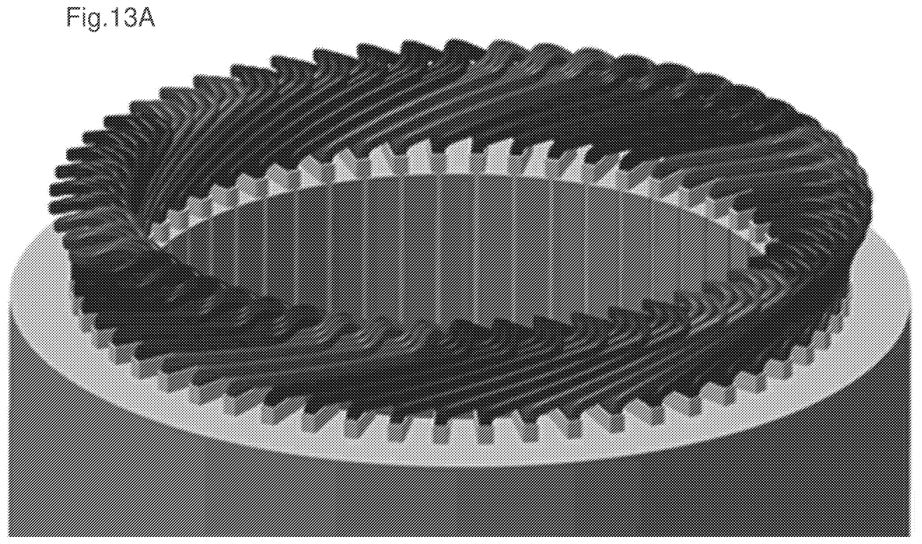

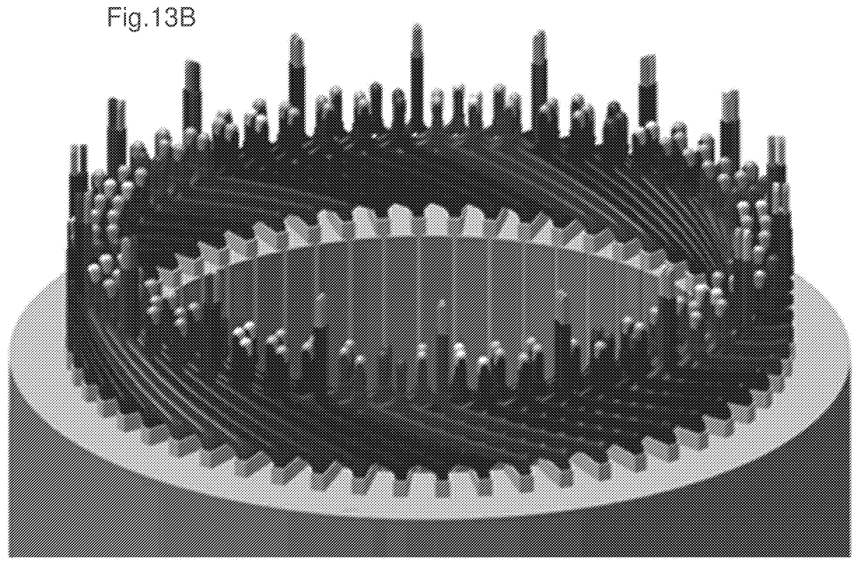

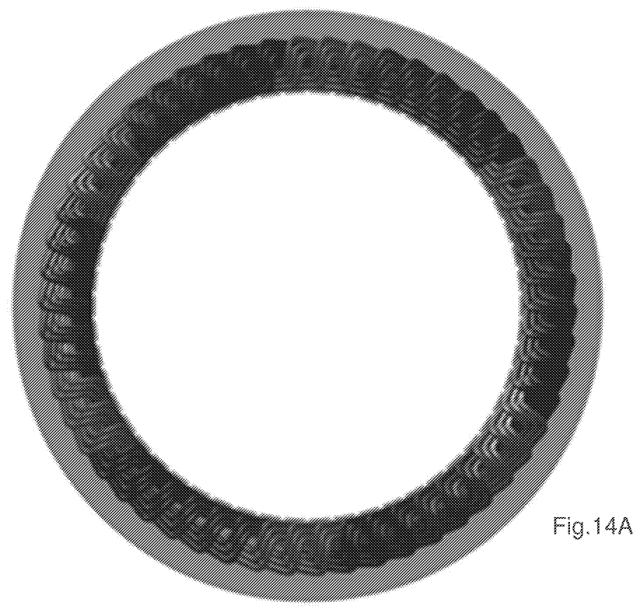

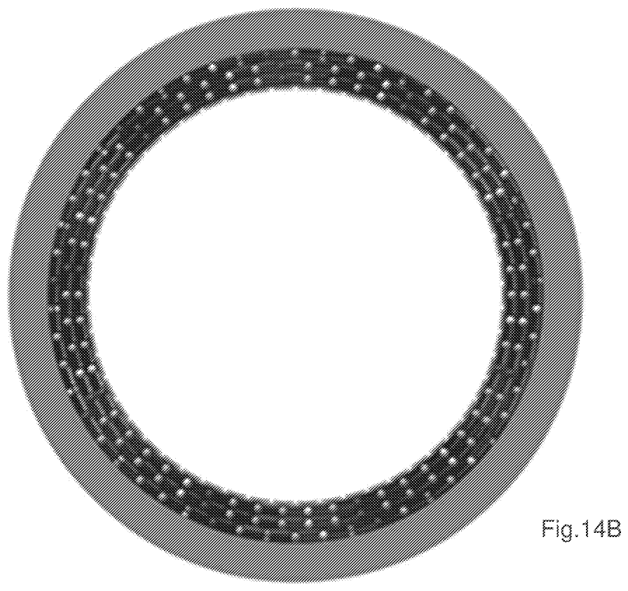

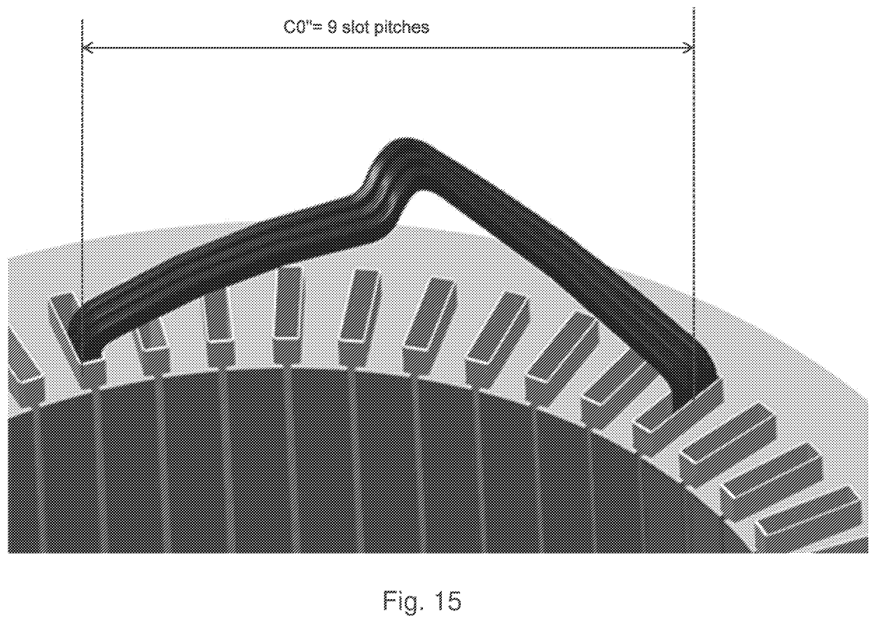

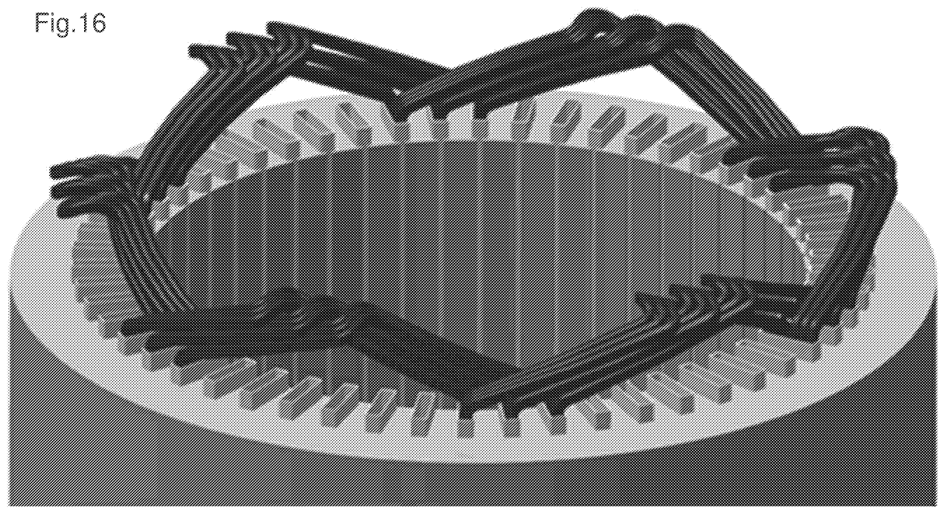

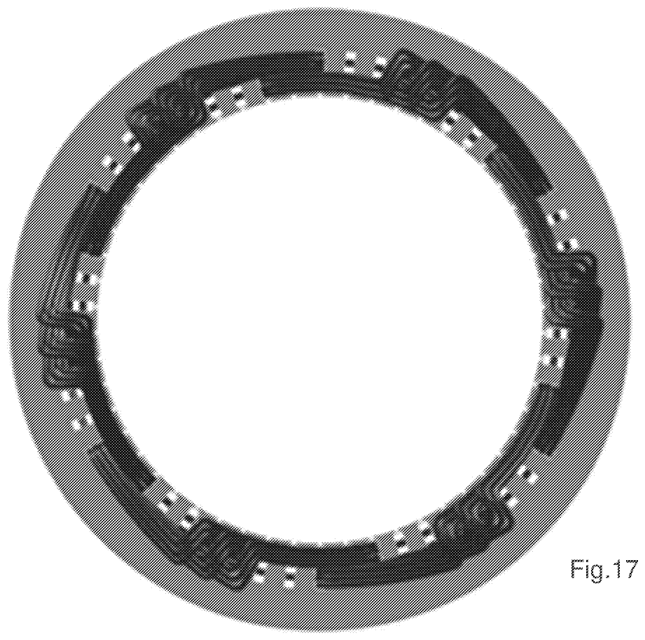

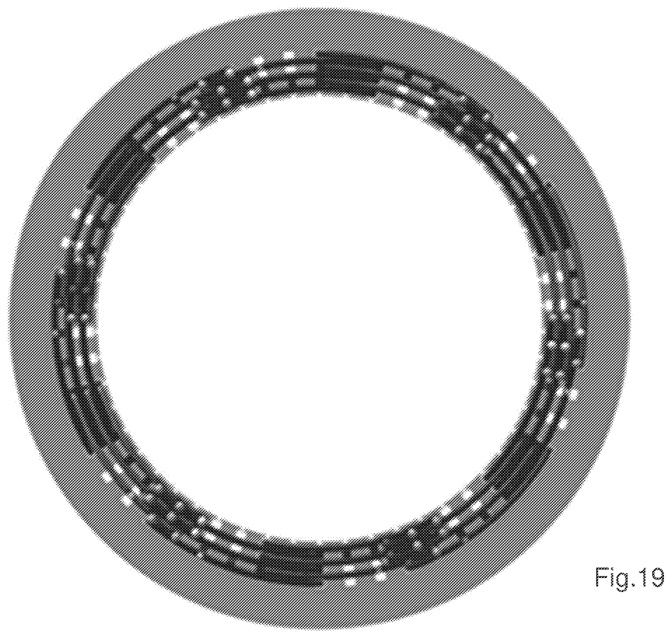

With reference to FIGS. 12, 13A, 13B, 14A, 14B, 15, 16, 17, 18, 19, 20, there is shown a second embodiment of the disclosure in which a stator 101 with single-crown bar conductor winding is realized using a plurality of groups each formed by three side-by-side bar conductors (K=3), wherein the distance in the circumferential angular direction between the two legs of each bar conductor at the insertion side is equal to nine slots.

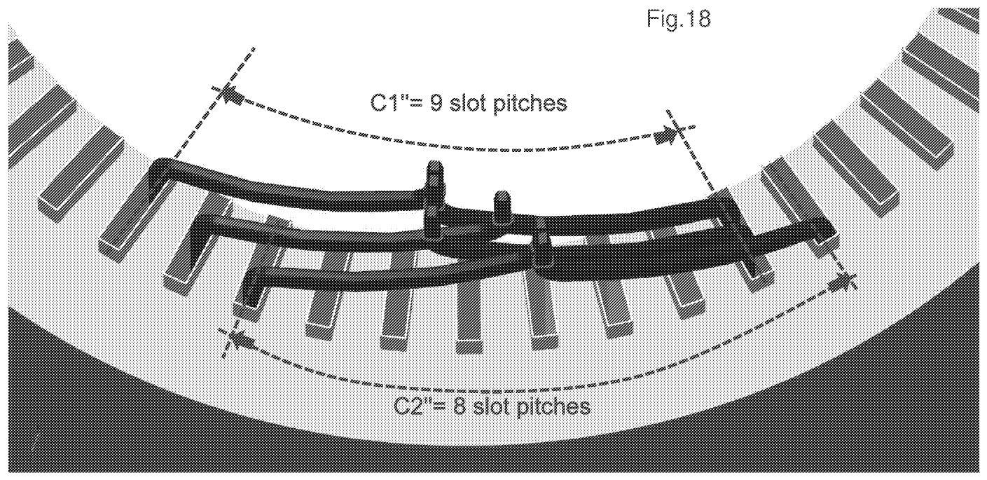

The above considerations relating to the first embodiment are applicable similarly to the second embodiment, with the difference that at the insertion side the bar conductors are arranged in groups of three connecting elements (instead of two) arranged side-by-side along the radial direction, the distance C0″ between the slots in which the two legs of the same conductor at the insertion side are inserted is equal to 9 slot pitches (instead of 4), the first distance C1″ between the slots in which the first legs of the first bent projecting ends of two different conductors radially adjacent at the twisting side are inserted is equal to 9 slot pitches (see FIG. 18) and the second distance C2″ between the slots in which the second legs of the second bent projecting ends of two different conductors radially adjacent at the twisting side are inserted is equal to 8 slot pitches (see FIG. 18 again): therefore in this second embodiment the distance C0″ is equal to the first distance C1″ and distance C0″ is different from the second distance C2″.

Alternatively, the distance C0″ (equal to 9 slot pitches) is different from the first distance C1″ (equal to 8 slot pitches) and the distance C0″ is equal to the second distance C2″ (equal to 9 slot pitches).

Alternatively, the distance C0″ is equal to both the first distance C1″ and the second distance C2″, i.e. C0″=C1″=C2″=9 slot pitches.

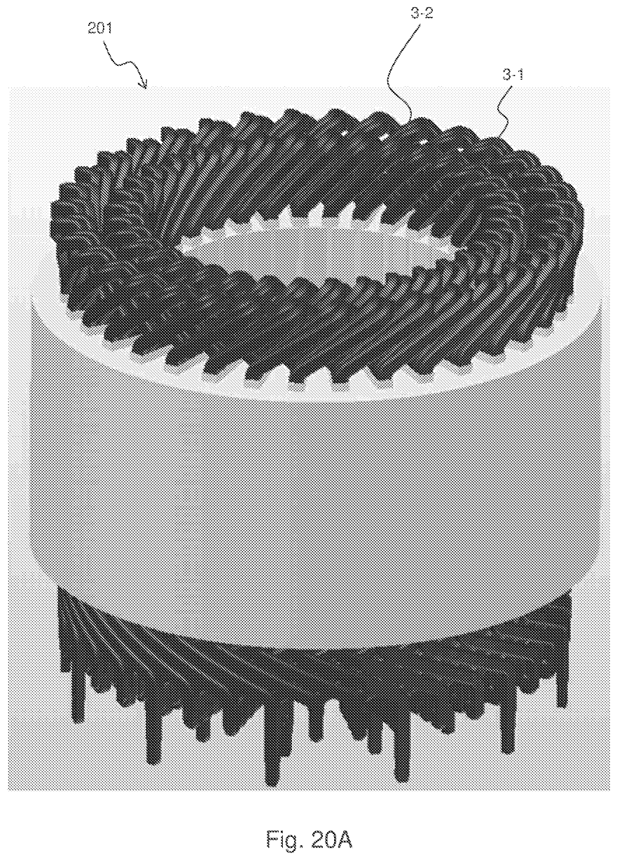

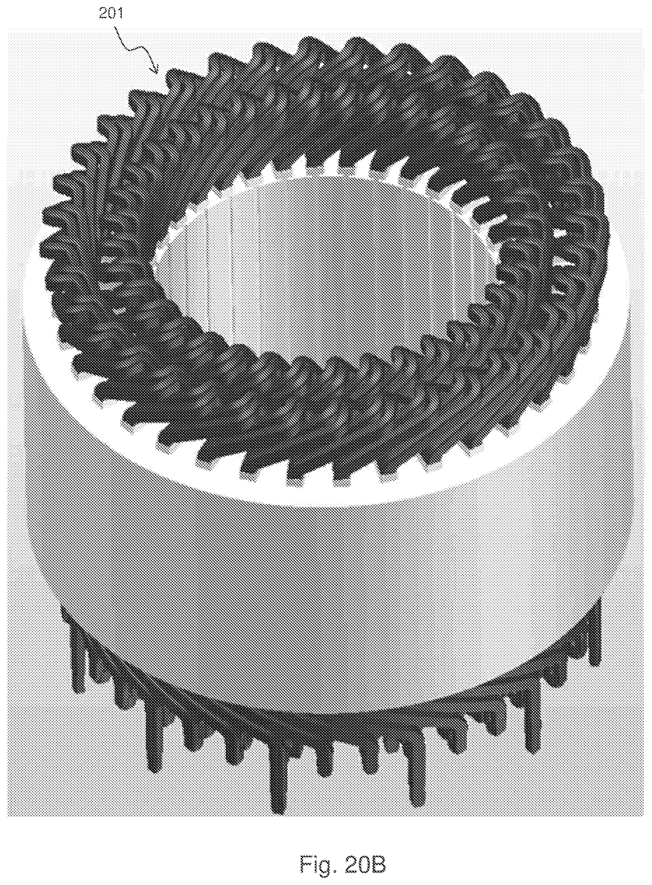

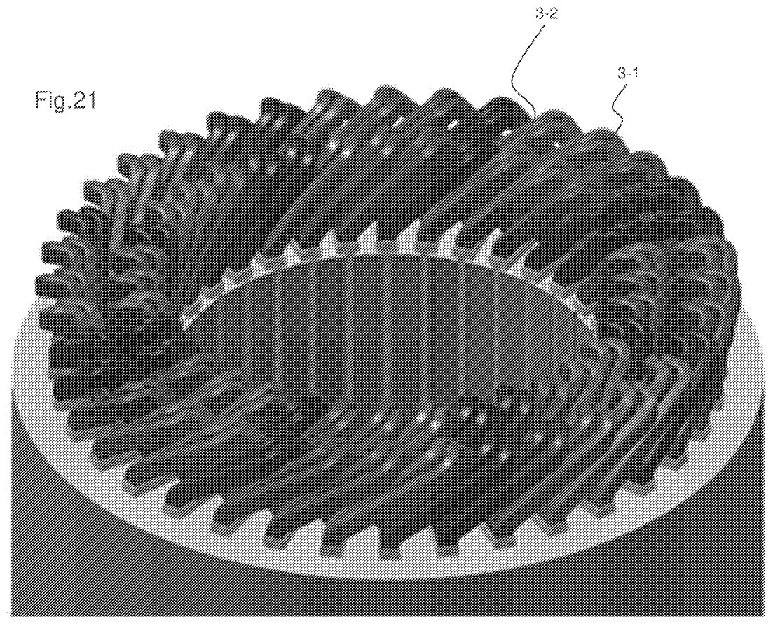

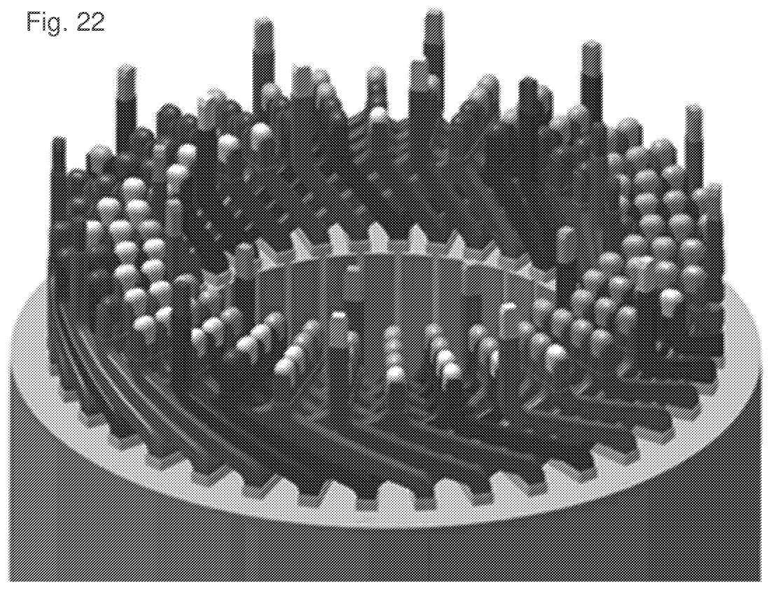

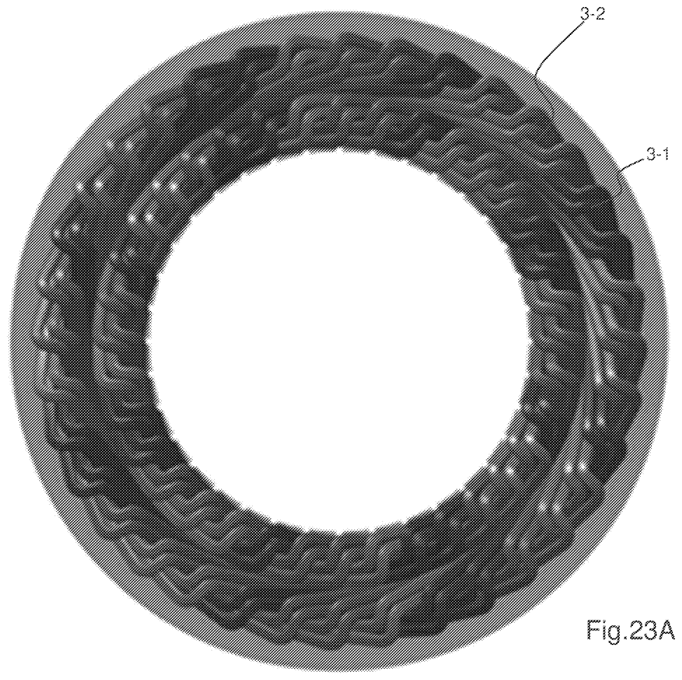

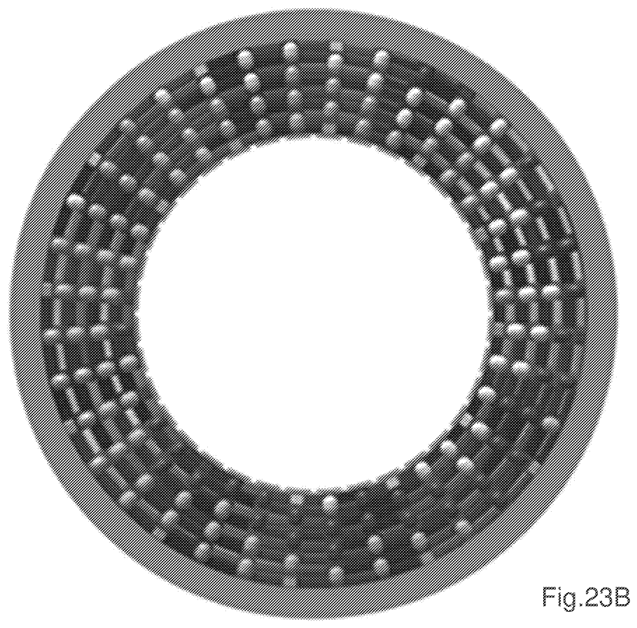

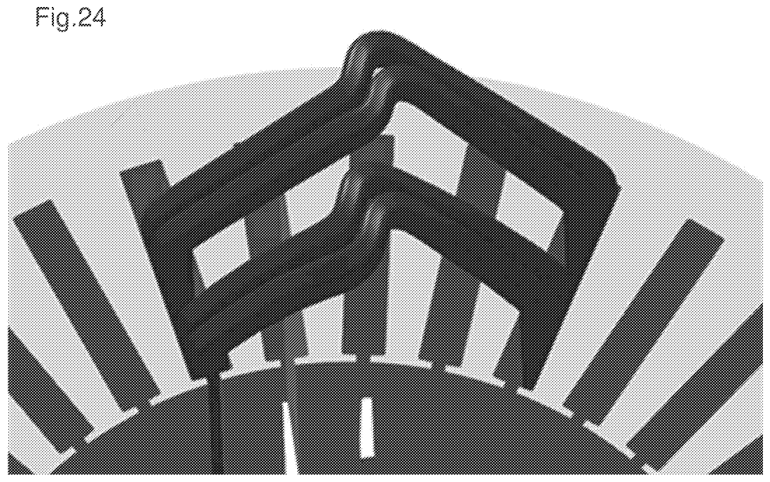

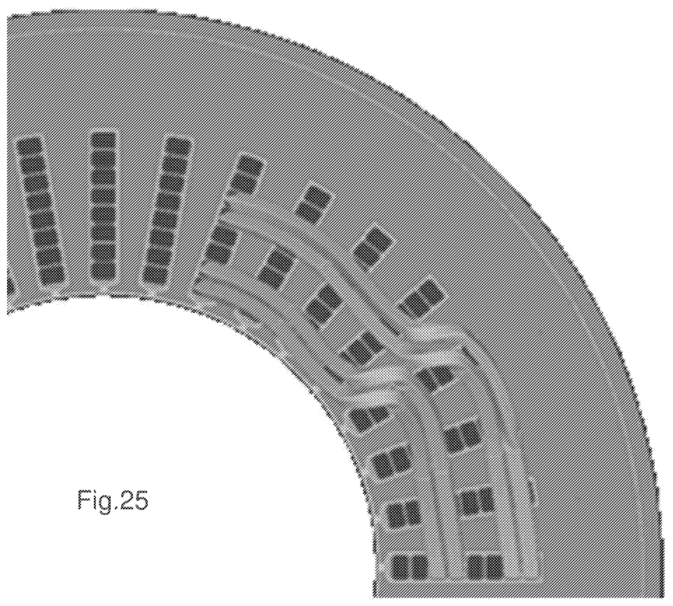

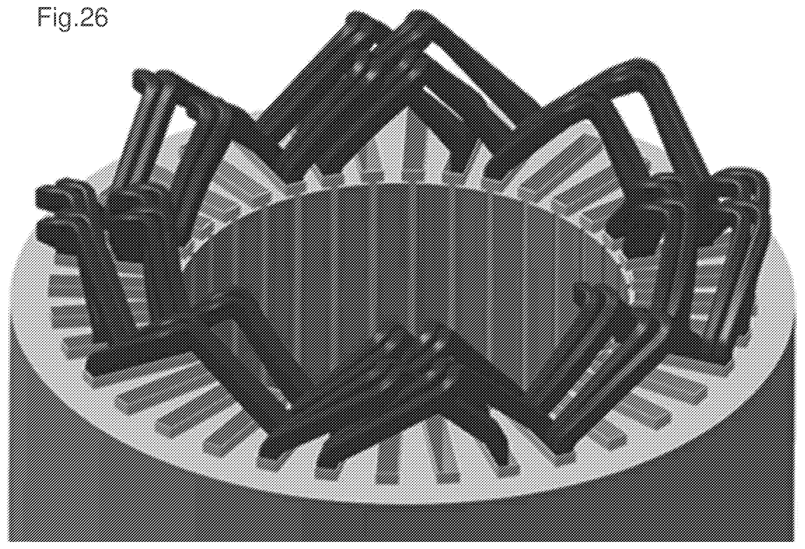

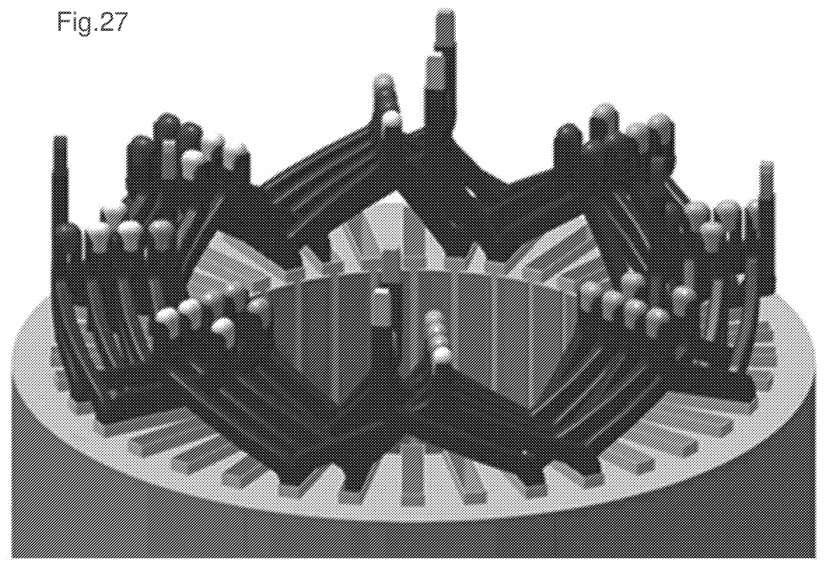

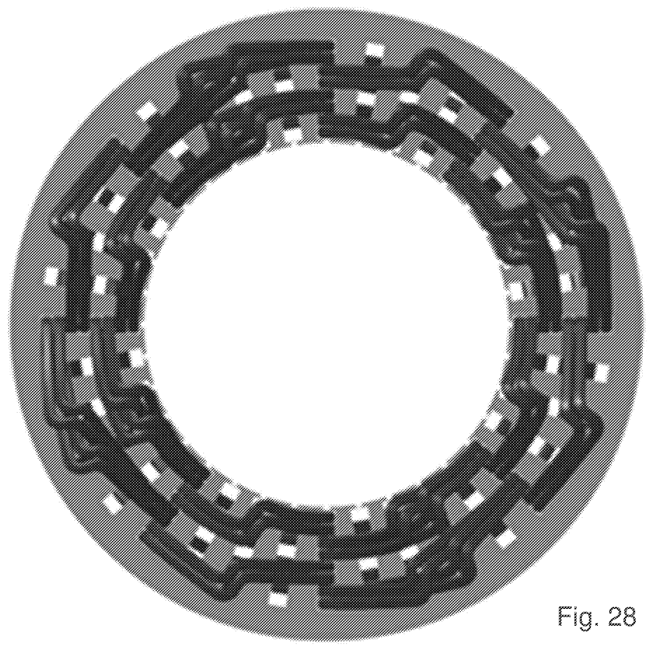

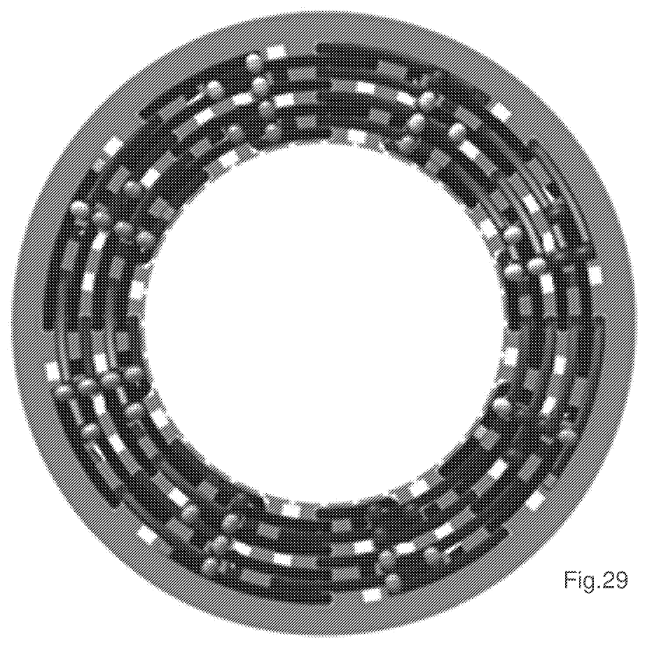

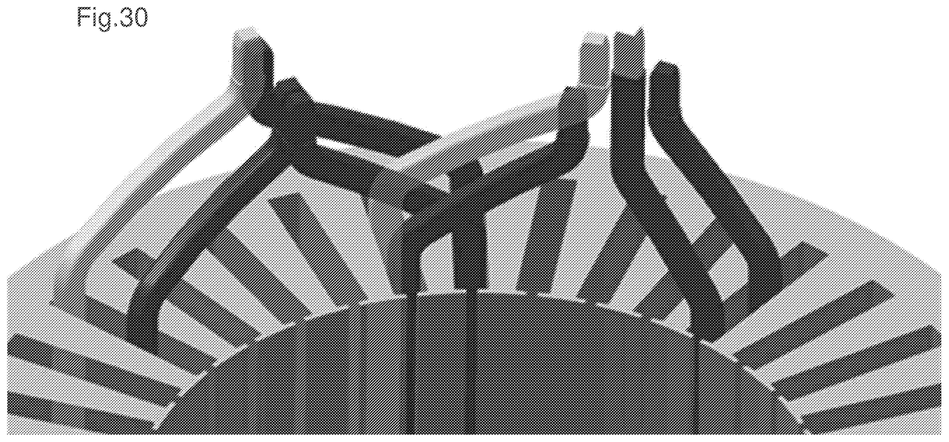

With reference to FIGS. 20A, 20B, 21, 22, 23A, 23B, 24, 25, 26, 27, 28, 29, 30, there is shown a third embodiment of the disclosure in which a winding stator 201 with bar conductors is realized with a stator winding 3 with two portion 3-1, 3-2 using a plurality of groups each formed by two side-by-side bar conductors.

The above considerations relating to the first embodiment are applicable similarly to the third embodiment, with the difference that the stator 201 comprises a stator winding formed by two winding portions 3-1, 3-2 (also referred to as “crowns”) which are concentric to each other at the insertion side and with the difference that there are at the twisting side one or more electrical connections between bent projecting ends of legs of the first winding portion 3-1 with respective bent projecting ends of legs of the second winding portion 3-2.

In particular, the stator 201 further comprises at the twisting side at least one further terminal element, each formed by the electrical connection between the bent projecting end of the first or second leg of a bar conductor of the winding portion 3-1 and the bent projecting end of the first or second leg of another bar conductor of the winding portion 3-2.

According to a fourth embodiment of the disclosure (not shown in the Figures), this differs from the first, second and third embodiments in that for each winding portion the value of the first distance C1 between the slots in which the first legs of the first bent projecting ends of two different conductors radially adjacent at the twisting side are inserted is equal to the value of the second distance C2 between the slots in which the second legs of the second bent projecting ends of two different conductors radially adjacent at the twisting side are inserted, and furthermore the value of the distance C0 between the slots in which the two legs of a same conductor at the insertion side are inserted is different from the value of the first and second distances C1, C2.

Furthermore in the fourth embodiment at least one winding portion comprises a further first terminal element defining a further first circumferential angular distance C1′ which is different from the first distance C1 defined by the first terminal elements of the same winding portion and/or comprises a further second terminal element defining a further second circumferential angular distance C2′ which is different from the second distance C2 defined by the second terminal elements of the same winding portion.

In particular, the at least one winding portion of the fourth embodiment comprises a plurality of first terminal elements 15_16 at the twisting side each formed by the electrical connection between the first bent projecting end 15-1 of the first leg of a bar conductor 15 and the first bent projecting end 16-1 of the first leg of another bar conductor 16, wherein the layer in which the first leg having the first bent projecting end of said bar conductor is inserted is radially adjacent to the layer in which the first leg having the first bent projecting end of the other bar conductor is inserted, and wherein, for each first terminal element 15_16 of said plurality, a first distance C1 measured in slot pitches is defined along the circumferential angular direction at the twisting side between the slot in which the first leg having the projecting end of a bar conductor of the first terminal element of said plurality is inserted and the slot in which the first leg connected to the first projecting end of another bar conductor of the same first terminal element of said plurality is inserted.

Further, the at least one winding portion of the fourth embodiment comprises a plurality of second terminal elements 12_13 at the twisting side formed by the electrical connection between the second bent projecting end of the second leg of a bar conductor and the second bent projecting end of the second leg of another bar conductor, wherein the layer in which the second leg having the second bent projecting end of said bar conductor is inserted is adjacent to the layer in which the second leg having the second projecting end bent of the other bar conductor is inserted, and wherein, for each second terminal element 12_13 of said further plurality, a second distance C2 measured in slot pitches is defined along the circumferential angular direction at the twisting side between the slot in which the second leg having the second projecting end of a bar conductor of the second terminal element is inserted and the slot in which the second leg having the second projecting end of another bar conductor of the same second terminal element is inserted.

According to the fourth embodiment, the first distance C1 and the second distance C2 at the twisting side are equal to each other and are different from the defined value of said distance C0 at the insertion side.

Further, the at least one winding portion of the fourth embodiment comprises at least one further first terminal element at the twisting side, each formed by the electrical connection between the first bent projecting end of the first leg of a bar conductor and the first bent projecting end of the first leg of another bar conductor, wherein the layer in which the first leg having the first bent projecting end of said bar conductor is inserted is adjacent to the layer in which the first leg having the first bent projecting end of the other bar conductor is inserted, and wherein, for each further first terminal element of the plurality, a further first distance measured in slot pitches is defined along the circumferential angular direction at the twisting side between the slot in which the first leg having the first projecting end of a bar conductor of the further first terminal element is inserted and the slot in which the first leg having the first projecting end of the other bar conductor of the same further first terminal element is inserted, and wherein the further first distance is different from said first distance.

Alternatively (or in combination with the further first terminal elements) the at least one winding portion of the fourth embodiment comprises at least one further second terminal element at the twisting side, each formed by the electrical connection between the second bent projecting end of the second leg of a bar conductor and the second bent projecting end of the second leg of another bar conductor, wherein the layer in which the second leg having the second bent projecting end of said bar conductor is inserted is adjacent to the layer in which the second leg having the second bent projecting end of the other bar conductor is inserted, wherein, for each further terminal element of the plurality, a further second distance measured in slot pitches is defined along the circumferential angular direction at the twisting side between the slot in which the second leg having the second projecting end of a bar conductor of the further second terminal element is inserted and the slot in which the second leg having the second projecting end of the other bar conductor of the same further second terminal element is inserted, and wherein the further second distance is different from said second distance.

According to a variant of the embodiments illustrated above, the stator winding comprises a plurality of parallel paths per phase, each parallel path comprising at least two portions, each portion comprising a plurality of bar conductors connected in series as illustrated in the embodiments illustrated above: in this case the stator winding comprises at least one jumper, each jumper adapted to electrically connect two legs that are not radially adjacent of bar conductors belonging to two different portions of a respective path of the plurality of parallel paths.

1-13. (canceled)

14. A winding stator with bar conductors for an electric machine, the stator comprising:
a stator core having a first face defining an insertion side and a second face defining a twisting side, wherein the first face is opposite to the second with respect to an axial direction defined by a main extension of the stator core, the stator core comprising a plurality of slots extending along the axial direction of the stator core between the first face and the second face;
a stator winding comprising a plurality of bar conductors connected together in series to form the stator winding, each bar conductor comprising:
a first leg and a second leg comprising respective portions inserted in different slots;
a connecting element adapted to electrically connect the first and the second leg at the insertion side;
a first end of the first leg projecting with respect to the second face of the stator core;
a second end of the second leg projecting with respect to the second face of the stator core;
wherein each slot comprises a plurality of first and/or second legs of different bar conductors arranged side-by-side along a radial direction of the stator core defined by a secondary extension of the stator core, so as to define a plurality of layers of legs that are concentric with respect to the axial direction of the stator core,
wherein said plurality of bar conductors is arranged at the insertion side in groups comprising at least two bar conductors having the respective first legs arranged side-by-side along the radial direction of a slot and having the respective second legs arranged side-by-side along the radial direction of another slot,
wherein, for each group of the plurality of bar conductors, the layer of the first leg of one conductor is radially distant from the layer of the second leg of the one conductor by a defined quantity equal to a number of bar conductors of each group,
wherein the stator winding comprises at least one winding portion, each portion comprising a plurality of groups of bar conductors organised so that the first legs of different groups are inserted into a same layers of different slots and so that the second legs of different groups are inserted into the same layers of different slots,
and wherein, for the groups of the plurality of bar conductors of each winding portion, a distance in a circumferential angular direction at the insertion side between the slot in which the first leg of each bar conductor is inserted and the slot in which the second leg of the same bar conductor is inserted is equal to a defined value measured in slot pitches,
each winding portion comprising:
a plurality of first terminal elements at the twisting side each formed by the electrical connection between a first bent projecting end of the first leg of a bar conductor and the first bent projecting end of the first leg of another bar conductor, wherein the layer in which the first leg having the first bent projecting end of said bar conductor is inserted is radially adjacent to the layer in which the first leg having the first bent projecting end of an other bar conductor is inserted, and
wherein, for each first terminal element of said plurality, a first distance measured in slot pitches is defined along the circumferential angular direction at the twisting side between the slot in which the first leg having the first projecting end of a bar conductor of the first terminal element of said plurality is inserted and the slot in which the first leg connected to the first projecting end of another bar conductor of the same first terminal element of said plurality is inserted;
a plurality of second terminal elements at the twisting side formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted,
and wherein, for each second terminal element of said plurality of second terminal elements, a second distance measured in slot pitches is defined along the circumferential angular direction at the twisting side between the slot in which the second leg having the second projecting end of a bar conductor of the second terminal element is inserted and the slot in which the second leg having the second projecting end of another bar conductor of the same second terminal element is inserted;
wherein at least one between the first distance and the second distance at the twisting side is equal to the defined value of said distance at the insertion side.

15. The stator according to claim 14, wherein the first distance and the second distance at the twisting side are equal to the defined value of said distance at the insertion side.

16. The stator according to claim 14, wherein:
L is the number of layers of the stator winding;
K is the number of bar conductors of the groups of each winding portion,
wherein K is an integer equal to L/2 or is a sub-multiple of L/2;
wherein the number of winding portions is equal to L/(2*K).

17. The stator according to claim 14, wherein at least one winding portion further comprises at least one third terminal element at the twisting side, each third terminal element being formed by the electrical connection between the first bent projecting end of the first leg of a bar conductor and the second bent projecting end of the second leg of another bar conductor,
wherein the layer in which the first leg having the first bent projecting end of said bar conductor is inserted is adjacent to the layer in which the second leg having the second bent projecting end of the other bar conductor is inserted.

18. The stator according to claim 14, wherein at least one winding portion further comprises at least one of the following terminal elements:
a further first terminal element at the twisting side, each formed by the electrical connection between the first bent projecting end of the first leg of a bar conductor and the first bent projecting end of the first leg of another bar conductor,
wherein the layer in which the first leg having the first bent projecting end of said bar conductor is inserted is adjacent to the layer in which the first leg having the first bent projecting end of the other bar conductor is inserted,
and wherein, for each further first terminal element of the plurality, a further first distance measured in slot pitches is defined along the circumferential angular direction at the twisting side between the slot in which the first leg having the first projecting end of a bar conductor of the further first terminal element is inserted and the slot in which the first leg having the first projecting end of the other bar conductor of the same further first terminal element is inserted,
and wherein the further first distance is different from said first distance;
a further second terminal element at the twisting side, each formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted,
and wherein, for each further second terminal element of the plurality, a further second distance measured in slot pitches is defined along the circumferential angular direction at the twisting side between the slot in which the second leg having the second projecting end of a bar conductor of the further terminal element is inserted and the slot in which the second leg having the second projecting end of the other bar conductor of the same further terminal element is inserted,
and wherein the further second distance is different from said second distance.

19. The stator according to claim 14, the stator winding comprising at least two winding portions,
the stator winding further comprising at the twisting side at least one further terminal element, each formed by the electrical connection between the bent projecting end of the first or second leg of a bar conductor of a winding portion and the bent projecting end of the first or second leg of another bar conductor of another winding portion.

20. The stator according to claim 14, wherein the number of conductors of each group is equal to two and wherein, for at least one winding portion, the values in slot pitches of the defined distance, of the first and of the second distance are selected from one of the following list:
the value of the defined distance is equal to four, the value of the first distance is equal to four and the value of the second distance is equal to five;
the value of the defined distance is equal to four, the value of the first distance is equal to five and the value of the second distance is equal to four;
the value of the defined distance is equal to five, the value of the first distance is equal to four and the value of the second distance is equal to five.

21. A winding stator with bar conductors for an electric machine, the stator comprising:
a stator core having a first face defining an insertion side and a second face defining a twisting side, wherein the first face is opposite to the second with respect to an axial direction defined by a main extension of the stator core, the stator core comprising a plurality of slots extending along the axial direction of the stator core between the first face and the second face;
a stator winding comprising a plurality of bar conductors connected together in series to form the stator winding, each bar conductor comprising:
a first leg and a second leg comprising respective portions inserted in different slots;
a connecting element adapted to electrically connect the first and the second leg at the insertion side;
a first end of the first leg projecting with respect to the second face of the stator core;
a second end of the second leg projecting with respect to the second face of the stator core;
wherein each slot comprises a plurality of first and/or second legs of different bar conductors arranged side by side along a radial direction of the stator core defined by a secondary extension of the stator core, so as to define a plurality of layers of legs that are concentric with respect to the axial direction of the stator core,
wherein said plurality of bar conductors is arranged at the insertion side into groups comprising at least two bar conductors having the respective first legs arranged side by side along the radial direction of a slot and having the respective second legs arranged side by side along the radial direction of another slot,
wherein, for each group of the plurality of bar conductors, the layer of the first leg of one conductor is radially distant from the layer of the second leg of the one conductor by a defined quantity equal to a number of bar conductors in each group,
wherein the stator winding comprises at least one winding portion, each portion comprising a plurality of groups of bar conductors organised so that the first legs of different groups are inserted in a same layers of different slots and so that the second legs of different groups are inserted in the same layers of different slots,
and wherein, for the groups of the plurality of bar conductors of each winding portion, a distance in a circumferential angular direction at the insertion side between the slot in which the first leg of each bar conductor is inserted and the slot in which the second leg of the same bar conductor is inserted is equal to a defined value measured in slot pitches,
each winding portion comprising:
a plurality of first terminal elements at the twisting side each formed by the electrical connection between a first bent projecting end of the first leg of a bar conductor and the first bent projecting end of the first leg of another bar conductor, wherein the layer in which the first leg having the first bent projecting end of said bar conductor is inserted is radially adjacent to the layer in which the first leg having the first bent projecting end of an other bar conductor is inserted,
and wherein, for each first terminal element of said plurality, a first distance measured in slot pitches is defined along the circumferential angular direction on the twisting side between the slot in which the first leg having the first projecting end of a bar conductor of the first terminal element of said plurality is inserted and the slot in which the first leg connected to the first projecting end of another bar conductor of the same first terminal element of said plurality is inserted;
a plurality of second terminal elements at the twisting side formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted, and
wherein, for each second terminal element of said plurality of second terminal elements, a second distance measured in slot pitches is defined along the circumferential angular direction on the twisting side between the slot in which the second leg having the second projecting end of a bar conductor of the second terminal element is inserted and the slot in which the second leg having the second projecting end of another bar conductor of the same second terminal element is inserted;
wherein the first distance and the second distance on the twisting side are equal to each other and are different from the defined value of said distance to the insertion side,
wherein at least one winding portion further comprises at least one of the following further terminal elements:
a further first terminal element at the twisting side, each formed by the electrical connection between the first bent projecting end of the first leg of a bar conductor and the first bent projecting end of the first leg of another bar conductor, wherein the layer in which the first leg having the first bent projecting end of said bar conductor is inserted is adjacent to the layer in which the first leg having the first bent projecting end of the other bar conductor is inserted,
wherein, for each further first terminal element of the plurality, a further first distance measured in slot pitches is defined along the circumferential angular direction on the twisting side between the slot in which the first leg having the first projecting end of a bar conductor of the further first terminal element is inserted and the slot in which the first leg having the first projecting end of the other bar conductor of the same further first terminal element is inserted,
and wherein the further first distance is different from said first distance;
a further second terminal element at the twisting side, each formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted,
wherein, for each further terminal element of the plurality, a further second distance measured in slot pitches is defined along the circumferential angular direction on the twisting side between the slot in which the second leg having the second projecting end of a bar conductor of the further second terminal element is inserted and the slot in which the second leg having the second projecting end of the other bar conductor of the same further second terminal element is inserted,
and wherein the further second distance is different from said second distance.

22. The stator according to claim 21, wherein at least one winding portion further comprises at least one further terminal element at the twisting side, each further terminal element being formed by the electrical connection between the first bent projecting end of the first leg of a bar conductor and the second bent projecting end of the second leg of another bar conductor,
wherein the layer in which the first leg having the first bent projecting end of said bar conductor is inserted is adjacent to the layer in which the second leg having the second bent projecting end of the other bar conductor is inserted.

23. The stator according to claim 21, the stator winding comprising at least two winding portions,
the stator winding further comprising at the twisting side at least one third terminal element, each formed by the electrical connection between the bent projecting end of the first or second leg of a bar conductor of a winding portion and the bent projecting end of the first or second leg of another bar conductor of another winding portion,
wherein:
L is the number of layers of the stator winding;
K is the number of bar conductors of the groups of each winding portion,
wherein K is an integer sub-multiple of L/2;
wherein the number of winding portions is equal to L/(2*K).

24. The stator according to claim 23, wherein at least one winding portion of the at least two winding portions further comprises at least one fourth terminal element at the twisting side, each fourth terminal element being formed by the electrical connection between the first bent projecting end of the first leg of a bar conductor and the second projecting bent end of the second leg of another bar conductor,
wherein the layer in which the first leg having the first bent projecting end of said bar conductor is inserted is adjacent to the layer in which the second leg having the second bent projecting end of the other bar conductor is inserted.

25. The stator according to claim 21, wherein for each conductor the first leg is inserted in a slot of a layer which is radially more internal than the layer of the slot in which the second leg is inserted.

26. An electric or hybrid vehicle comprising a winding stator, the stator comprising:
a stator core having a first face defining an insertion side and a second face defining a twisting side, wherein the first face is opposite to the second with respect to an axial direction defined by a main extension of the stator core, the stator core comprising a plurality of slots extending along the axial direction of the stator core between the first face and the second face;
a stator winding comprising a plurality of bar conductors connected together in series to form the stator winding, each bar conductor comprising:
a first leg and a second leg comprising respective portions inserted in different slots;
a connecting element adapted to electrically connect the first and the second leg at the insertion side;
a first end of the first leg projecting with respect to the second face of the stator core;
a second end of the second leg projecting with respect to the second face of the stator core;
wherein each slot comprises a plurality of first and/or second legs of different bar conductors arranged side-by-side along a radial direction of the stator core defined by a secondary extension of the stator core, so as to define a plurality of layers of legs that are concentric with respect to the axial direction of the stator core,
wherein said plurality of bar conductors is arranged at the insertion side in groups comprising at least two bar conductors having the respective first legs arranged side-by-side along the radial direction of a slot and having the respective second legs arranged side-by-side along the radial direction of another slot,
wherein, for each group of the plurality of bar conductors, the layer of the first leg of one conductor is radially distant from the layer of the second leg of the one conductor by a defined quantity equal to a number of bar conductors of each group,
wherein the stator winding comprises at least one winding portion, each portion comprising a plurality of groups of bar conductors organised so that the first legs of different groups are inserted into the same layers of different slots and so that the second legs of different groups are inserted into the same layers of different slots,
and wherein, for the groups of the plurality of bar conductors of each winding portion, a distance in a circumferential angular direction at the insertion side between the slot in which the first leg of each bar conductor is inserted and the slot in which the second leg of the same bar conductor is inserted is equal to a defined value measured in slot pitches,
each winding portion comprising:
a plurality of first terminal elements at the twisting side each formed by the electrical connection between a first bent projecting end of the first leg of a bar conductor and the first bent projecting end of the first leg of another bar conductor, wherein the layer in which the first leg having the first bent projecting end of said bar conductor is inserted is radially adjacent to the layer in which the first leg having the first bent projecting end of the other bar conductor is inserted,
and wherein, for each first terminal element of said plurality, a first distance measured in slot pitches is defined along the circumferential angular direction at the twisting side between the slot in which the first leg having the first projecting end of a bar conductor of the first terminal element of said plurality is inserted and the slot in which the first leg connected to the first projecting end of another bar conductor of the same first terminal element of said plurality is inserted;
a plurality of second terminal elements at the twisting side formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of an other bar conductor is inserted, and
wherein, for each second terminal element of said plurality of second terminal elements, a second distance measured in slot pitches is defined along the circumferential angular direction at the twisting side between the slot in which the second leg having the second projecting end of a bar conductor of the second terminal element is inserted and the slot in which the second leg having the second projecting end of another bar conductor of the same second terminal element is inserted;
wherein at least one between the first distance and the second distance at the twisting side is equal to the defined value of said distance at the insertion side.

27. The stator according to claim 15, wherein:
L is the number of layers of the stator winding;
K is the number of bar conductors of the groups of each winding portion,
wherein K is an integer equal to L/2 or is a sub-multiple of L/2;
wherein the number of winding portions is equal to L/(2*K).

28. The stator according to claim 15, wherein at least one winding portion further comprises at least one third terminal element at the twisting side, each third terminal element being formed by the electrical connection between the first bent projecting end of the first leg of a bar conductor and the second bent projecting end of the second leg of another bar conductor,
wherein the layer in which the first leg having the first bent projecting end of said bar conductor is inserted is adjacent to the layer in which the second leg having the second bent projecting end of the other bar conductor is inserted.

29. The stator according to claim 15, wherein at least one winding portion further comprises at least one of the following terminal elements:
a further first terminal element at the twisting side, each formed by the electrical connection between the first bent projecting end of the first leg of a bar conductor and the first bent projecting end of the first leg of another bar conductor,
wherein the layer in which the first leg having the first bent projecting end of said bar conductor is inserted is adjacent to the layer in which the first leg having the first bent projecting end of the other bar conductor is inserted,
and wherein, for each further first terminal element of the plurality, a further first distance measured in slot pitches is defined along the circumferential angular direction at the twisting side between the slot in which the first leg having the first projecting end of a bar conductor of the further first terminal element is inserted and the slot in which the first leg having the first projecting end of the other bar conductor of the same further first terminal element is inserted,
and wherein the further first distance is different from said first distance;
a further second terminal element at the twisting side, each formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted,
and wherein, for each further second terminal element of the plurality, a further second distance measured in slot pitches is defined along the circumferential angular direction at the twisting side between the slot in which the second leg having the second projecting end of a bar conductor of the further terminal element is inserted and the slot in which the second leg having the second projecting end of the other bar conductor of the same further terminal element is inserted,
and wherein the further second distance is different from said second distance.

30. The stator according to claim 15, the stator winding comprising at least two winding portions,
the stator winding further comprising at the twisting side at least one further terminal element, each formed by the electrical connection between the bent projecting end of the first or second leg of a bar conductor of a winding portion and the bent projecting end of the first or second leg of another bar conductor of another winding portion.

31. The stator according to claim 15, wherein the number of conductors of each group is equal to two and wherein, for at least one winding portion, the values in slot pitches of the defined distance, of the first and of the second distance are selected from one of the following list:
the value of the defined distance is equal to four, the value of the first distance is equal to four and the value of the second distance is equal to five;
the value of the defined distance is equal to four, the value of the first distance is equal to five and the value of the second distance is equal to four;
the value of the defined distance is equal to five, the value of the first distance is equal to four and the value of the second distance is equal to five.

32. An electric or hybrid vehicle comprising a winding stator, the stator comprising:
a stator core having a first face defining an insertion side and a second face defining a twisting side, wherein the first face is opposite to the second with respect to an axial direction defined by a main extension of the stator core, the stator core comprising a plurality of slots extending along the axial direction of the stator core between the first face and the second face;
a stator winding comprising a plurality of bar conductors connected together in series to form the stator winding, each bar conductor comprising:
a first leg and a second leg comprising respective portions inserted in different slots;
a connecting element adapted to electrically connect the first and the second leg at the insertion side;
a first end of the first leg projecting with respect to the second face of the stator core;
a second end of the second leg projecting with respect to the second face of the stator core;
wherein each slot comprises a plurality of first and/or second legs of different bar conductors arranged side by side along a radial direction of the stator core defined by a secondary extension of the stator core, so as to define a plurality of layers of legs that are concentric with respect to the axial direction of the stator core,
wherein said plurality of bar conductors is arranged at the insertion side into groups comprising at least two bar conductors having the respective first legs arranged side by side along the radial direction of a slot and having the respective second legs arranged side by side along the radial direction of another slot,
wherein, for each group of the plurality of bar conductors, the layer of the first leg of one conductor is radially distant from the layer of the second leg of the one conductor by a defined quantity equal to a number of bar conductors in each group,
wherein the stator winding comprises at least one winding portion, each portion comprising a plurality of groups of bar conductors organised so that the first legs of different groups are inserted in the same layers of different slots and so that the second legs of different groups are inserted in the same layers of different slots,
and wherein, for the groups of the plurality of bar conductors of each winding portion, a distance in a circumferential angular direction at the insertion side between the slot in which the first leg of each bar conductor is inserted and the slot in which the second leg of the same bar conductor is inserted is equal to a defined value measured in slot pitches,
each winding portion comprising:
a plurality of first terminal elements at the twisting side each formed by the electrical connection between the first bent projecting end of the first leg of a bar conductor and a first bent projecting end of the first leg of another bar conductor, wherein the layer in which the first leg having the first bent projecting end of said bar conductor is inserted is radially adjacent to the layer in which the first leg having the first bent projecting end of an other bar conductor is inserted, and
wherein, for each first terminal element of said plurality, a first distance measured in slot pitches is defined along the circumferential angular direction on the twisting side between the slot in which the first leg having the first projecting end of a bar conductor of the first terminal element of said plurality is inserted and the slot in which the first leg connected to the first projecting end of another bar conductor of the same first terminal element of said plurality is inserted;
a plurality of second terminal elements at the twisting side formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted, and
wherein, for each second terminal element of said plurality of second terminal elements, a second distance measured in slot pitches is defined along the circumferential angular direction on the twisting side between the slot in which the second leg having the second projecting end of a bar conductor of the second terminal element is inserted and the slot in which the second leg having the second projecting end of another bar conductor of the same second terminal element is inserted;
wherein the first distance and the second distance on the twisting side are equal to each other and are different from the defined value of said distance to the insertion side,
wherein at least one winding portion further comprises at least one of the following further terminal elements:
a further first terminal element at the twisting side, each formed by the electrical connection between the first bent projecting end of the first leg of a bar conductor and the first bent projecting end of the first leg of another bar conductor, wherein the layer in which the first leg having the first bent projecting end of said bar conductor is inserted is adjacent to the layer in which the first leg having the first bent projecting end of the other bar conductor is inserted,
wherein, for each further first terminal element of the plurality, a further first distance measured in slot pitches is defined along the circumferential angular direction on the twisting side between the slot in which the first leg having the first projecting end of a bar conductor of the further first terminal element is inserted and the slot in which the first leg having the first projecting end of the other bar conductor of the same further first terminal element is inserted,
and wherein the further first distance is different from said first distance;
a further second terminal element at the twisting side, each formed by the electrical connection between the second bent projecting end of the second leg of a bar conductor and the second bent projecting end of the second leg of another bar conductor,
wherein the layer in which the second leg having the second bent projecting end of said bar conductor is inserted is adjacent to the layer in which the second leg having the second bent projecting end of the other bar conductor is inserted, wherein, for each further terminal element of the plurality, a further second distance measured in slot pitches is defined along the circumferential angular direction on the twisting side between the slot in which the second leg having the second projecting end of a bar conductor of the further second terminal element is inserted and the slot in which the second leg having the second projecting end of the other bar conductor of the same further second terminal element is inserted, and
wherein the further second distance is different from said second distance.
